(19) United States
(12) Patent Application Publication
(10) Pub. No.: US 2026/0339424 A1
(43) Pub. Date: Oct. 29, 2026

(54) SENSOR-LADEN WEARABLE ARTICLES FOR CAUSING USER INTERACTIONS WITH ARTIFICIALLY-INTELLIGENT AGENTS PERSONALIZED FOR THE WEARABLE ARTICLES AND CONNECTABLE COMPONENTS THEREOF

(71) Applicant: Meta Platforms Technologies, LLC, Menlo Park, CA (US)

(72) Inventor: Andrew Garrod Bosworth, San Mateo, CA (US)

(21) Appl. No.: 19/641,464

(22) Filed: Apr. 7, 2026

Related U.S. Application Data
(60) Provisional application No. 63/793,576, filed on Apr. 23, 2025.

(51) Int. Cl. G06F 3/01; G06F 1/16

(52) U.S. Cl. CPC G06F 3/011; G06F 1/163

(57) ABSTRACT

An example method is provided for suggesting sensor-laden articles of manufacture based on predicted user intentions. The example method includes, when determining that a first wearable article of a user is in electronic communication with a processing device, obtaining sensor data from first sensors. The example method includes, based on the sensor data, determining a first set of capabilities provided by the first sensors. The example method includes, based on applying, to an AI model, (i) behavioral user data, and (ii) the sensor data from the first sensors, identifying an activity the user is predicted to perform. The example method includes, based on the identification of the predicted activity, identifying a second wearable article including second sensors having capabilities for detecting aspects of the activity that the user is predicted to perform. And the example method includes presenting an indication suggesting to the user to don the second wearable article.

### RELATED APPLICATION

This application claims priority to U.S. Provisional Application Serial No. 63/793,576, filed Apr. 23, 2025, entitled "Sensor-Laden Wearable Articles For Causing User Interactions With Artificially-Intelligent Agents Personalized For The Wearable Articles And Connectible Components Thereof," which is incorporated herein by reference.

### TECHNICAL FIELD

This relates generally to wearable devices, including but not limited to wearable devices having sensors configured to interact with one or more artificially-intelligent (AI) agents in electronic communication with the wearable devices.

### BACKGROUND

Smart wearable devices (e.g., electronic devices designed to be worn on the body, typically as an accessory or integrated into clothing) are gaining popularity. Such devices are capable of facilitating interactions between users and their surroundings.

Many of such devices are configured to collect data about user’s surroundings, and/or biometrics of the user (e.g., health data) with the user's approval and explicit opt in protocals.

AI systems are gaining popularity, but are still limited to traditional input/output (I/O) modalities (e.g., responding to a textual prompt input by a user at a user interface presented at a computer display). Existing AI systems are also generally limited to conventional form factors (e.g., laptops, smart phones, wrist-wearable devices) that do not typically allow for obtaining data about the wearer that would be relevant to the AI system.

As such, there is a need to address one or more of the above-identified challenges. A brief summary of solutions to the issues noted above are described below.

### SUMMARY

The embodiments described herein include sensor-laden wearable articles of manufacturer, including wearable devices and electronic clothing articles that are configured to obtain data (e.g., sensor data) while a user is performing an activity. The data obtained at the sensor-laden wearable articles of manufacture is provided to an AI system to make determinations related to a wearer’s performance of the activities.

In one example, a user is wearing smart glasses and a wrist-wearable device prepares to play golf. As the user gets dressed, the wrist-wearable device detects that the user has put on a sensor-laden polo shirt. The smart glasses and wrist-wearable device communicate with each other and recognize the shirt’s sensors, which can track heart rate and body temperature. Based on the user’s calendar showing a golf appointment and the type of clothing being worn, the system predicts the user is about to play golf. The smart glasses then display a friendly suggestion to put on a sensor-equipped wristband, explaining that the additional sensors will improve accuracy when tracking the user's golf swing. After the user dons the wristband, the system guides the user through warmup stretches tailored to golf, using data from all the connected sensors to ensure the user is properly prepared for the activity.

In another example, a user wearing an AR helmet paired with a wrist-wearable device receives equipment requirements for a set of field operations. The AR helmet displays a checklist of required sensing capabilities, such as heart-rate monitoring and motion detection, that have been determined by an AI model based on the specific operations to be performed. As the user puts on each piece of sensor-laden equipment, including a smart field jacket and smart cargo pants, the AR helmet updates the checklist in real time to show which items are connected and operational. If a sensor on one of the garments becomes impinged or malfunctions during the activity, the AR helmet presents an alert with specific instructions for resolving the issue, such as adjusting the pant leg to ensure proper sensor contact with the skin. The system continuously monitors whether all required sensing capabilities are being satisfied throughout the duration of the operations.

One example method of suggesting sensor-laden articles of manufacture to a user based on predicted intentions of the user is described herein. The example method includes, in accordance with determining that a first wearable article of manufacture associated with a user is in electronic communication with a processing device associated with a user, obtaining sensor data from one or more first sensors. The example method includes, based on the sensor data from the one or more first sensors, determining a first set of capabilities that is provided by the one or more first sensors. The example method includes, based on applying, to an AI model, (i) behavioral data about the user (e.g., calendar data, historical activity patterns, or user-specified preferences), and (ii) the sensor data from the one or more first sensors, identifying an activity that the user is predicted to perform while wearing the first wearable article of manufacture, wherein the behavioral data is used for the purpose of providing activity-related recommendations to the user. The example method includes, in response to the identification of the activity that the user is predicted to perform, identifying a second wearable article of manufacture, the second wearable article of manufacture including a second set of sensors, the second set of sensors having capabilities for detecting aspects of the activity that the user is predicted to perform. And the example method includes, in response to identifying the second wearable article of manufacture, presenting an indication suggesting to the user to don the second wearable article of manufacture.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A to 1E illustrate a first example of an AI system providing recommendations to a user about wearable articles of manufacture based on activities that the user is predicted to perform, in accordance with some embodiments.

FIGS. 2A to 2D illustrate a second example of an AI system providing recommendations to a user about wearable articles of manufacture based on interactions by the user with the AI systems, in accordance with some embodiments.

FIGS. 3A to 3H illustrate an example of users interacting with an AI system to determine and comply with usage requirements for an AI system during the performance of a set of military operations, in accordance with some embodiments.

FIG. 4 shows an example method flow chart for intelligently recommending sensor-laden articles of manufacture to a user based on activities that a user is predicted to perform, in accordance with some embodiments.

FIG. 5 shows an example method flow chart for intelligently recommending sensor-laden articles of manufacture to a user based on interactions by a user with an AI agent, in accordance with some embodiments.

FIG. 6 shows an example method flow chart for using an AI system to determine and facilitate compliance with a set of equipment requirements, in accordance with some embodiments.

FIGS. 7A, 7B, 7C-1, and 7C-2 illustrate example MR and AR systems, in accordance with some embodiments.

In accordance with customary practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with distinct types of extended-realities (XRs) such as mixed-reality (MR) and augmented-reality (AR) systems. MRs and ARs, as described herein, are any superimposed functionality and/or sensory-detectable presentation provided by MR and AR systems within a user’s physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user’s hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user’s hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user’s hand or another finger, on the user’s leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user’s possession (e.g., smartphones, laptops, imaging devices, intermediary devices, and/or other devices described herein).

The input modalities as alluded to above can be varied and are dependent on a user’s experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are distinct types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; such user data may be subject to data retention policies that limit how long the data is stored before being automatically deleted, de-identified, or otherwise made inaccessible, and users may review and request deletion of their stored data; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) IMUs for detecting, for example, angular rate, force, magnetic field, and/or changes in acceleration; (iv) heart rate sensors for measuring a user’s heart rate; (v) peripheral oxygen saturation (SpO₂) sensors for measuring blood oxygen saturation and/or other biometric data of a user; (vi) capacitive sensors for detecting changes in potential at a portion of a user’s body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user’s environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### AI-Facilitated Wearable Article of Manufacture Selection

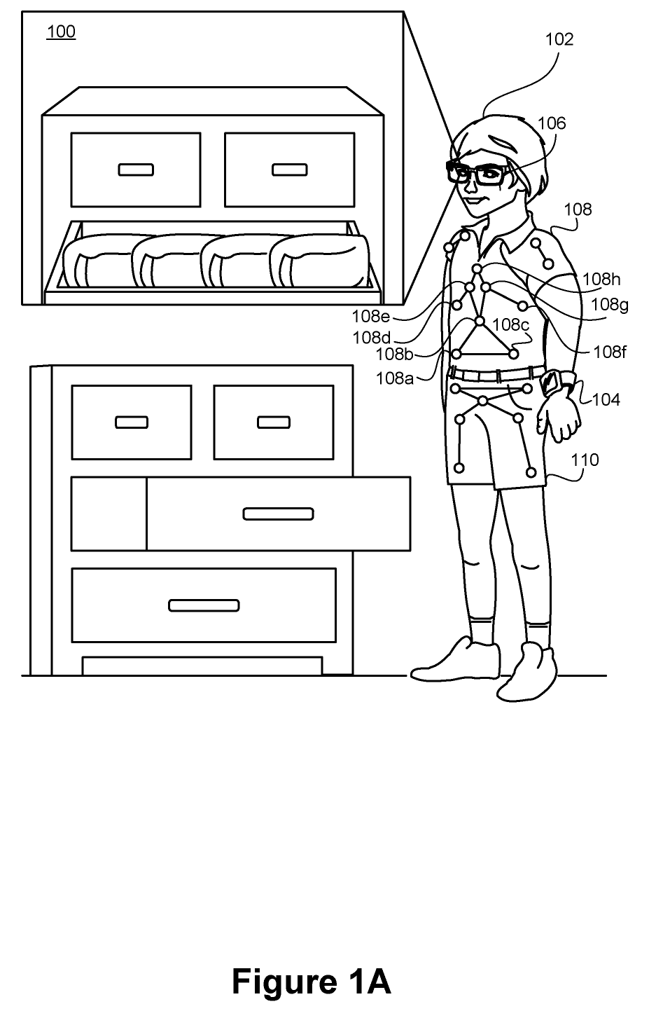

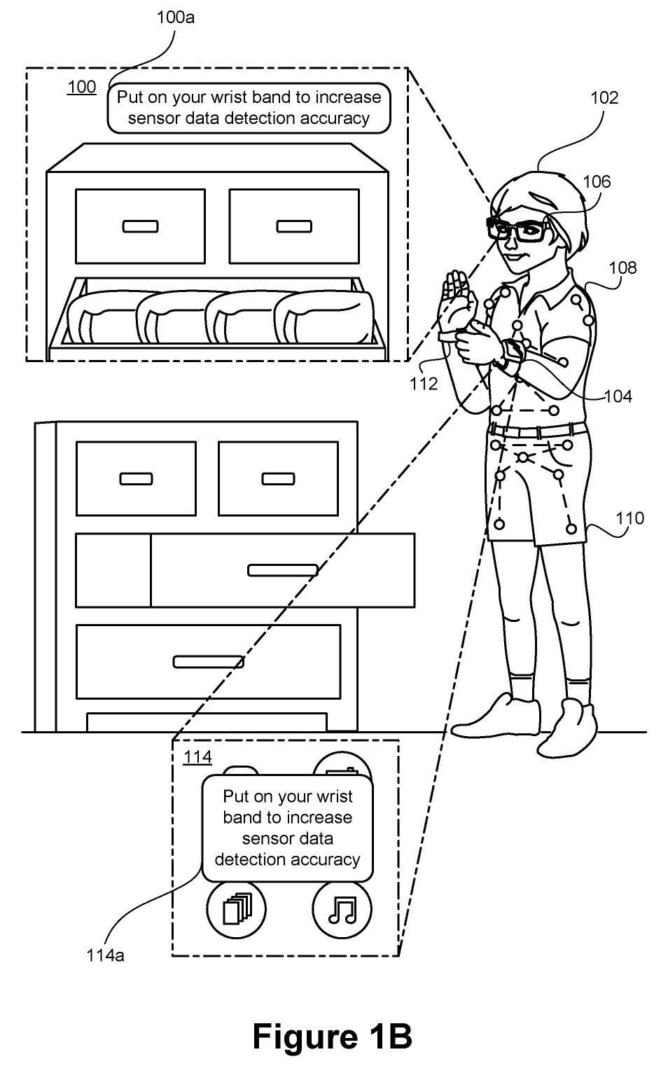

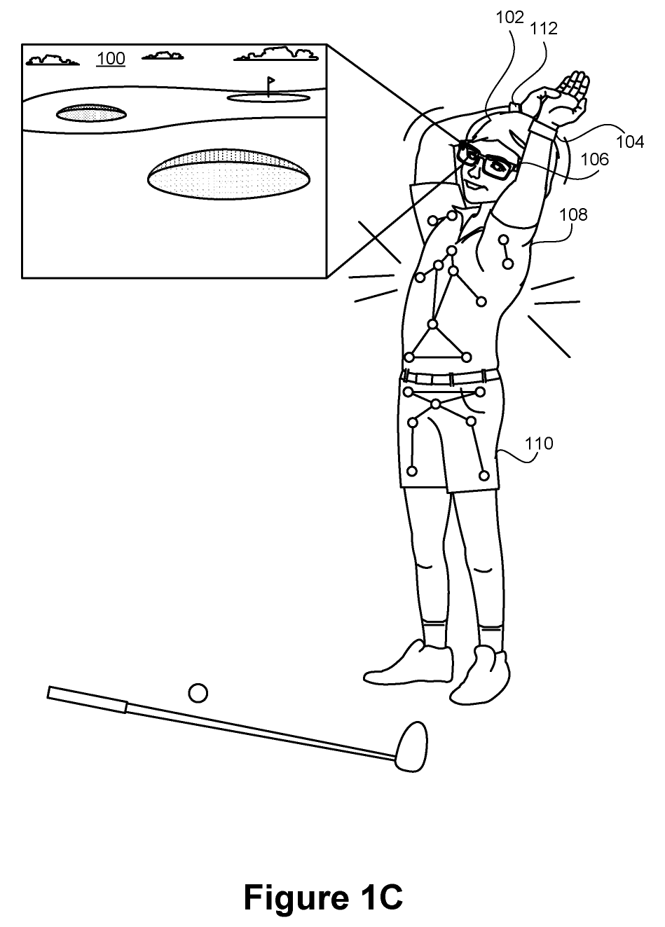

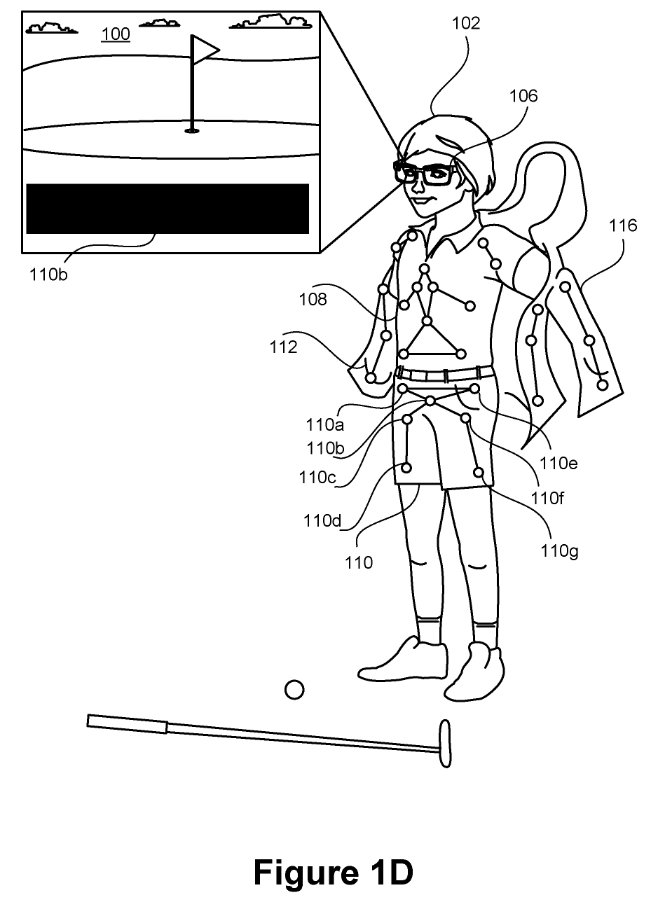

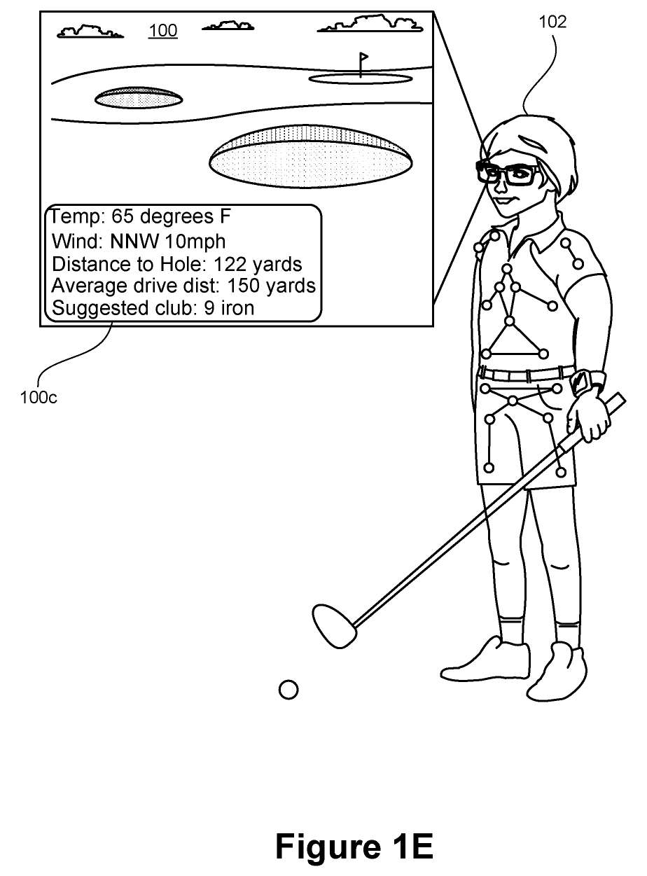

FIGS. 1A-1E illustrate a first example of an AI system providing recommendations to a user about wearable articles of manufacture based on activities that the user is predicted to perform, in accordance with some embodiments. FIG. 1A further illustrates the user 102 wearing one or more articles of manufacture (e.g., a smart shirt 108, smart shorts 110) configured to couple to at least one of a head-wearable device 106 and/or a wrist-wearable device 104. Additionally, the one or more articles of manufacture are able collect biopotential data from the body of the user 102 body and share that information with the one or more wearable devices including the head-wearable device 106 and the wrist-wearable device 104.. FIG. 1A further illustrates the user 102 getting ready to play golf and viewing a scene 100 that includes a dresser with additional wearable articles of manufacture. In preparation for playing golf, the user 102 puts on several smart wearable articles of manufacture. In some embodiments, a scene 100 is displayed at the integrated display at the head-wearable device 106.

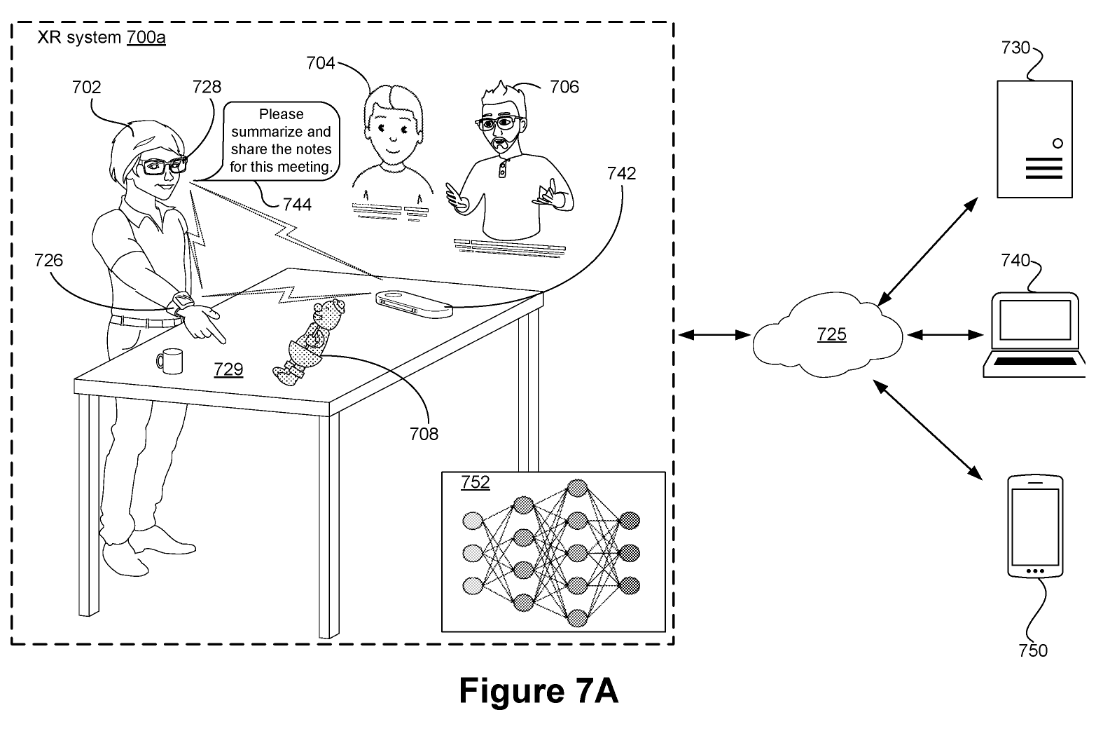

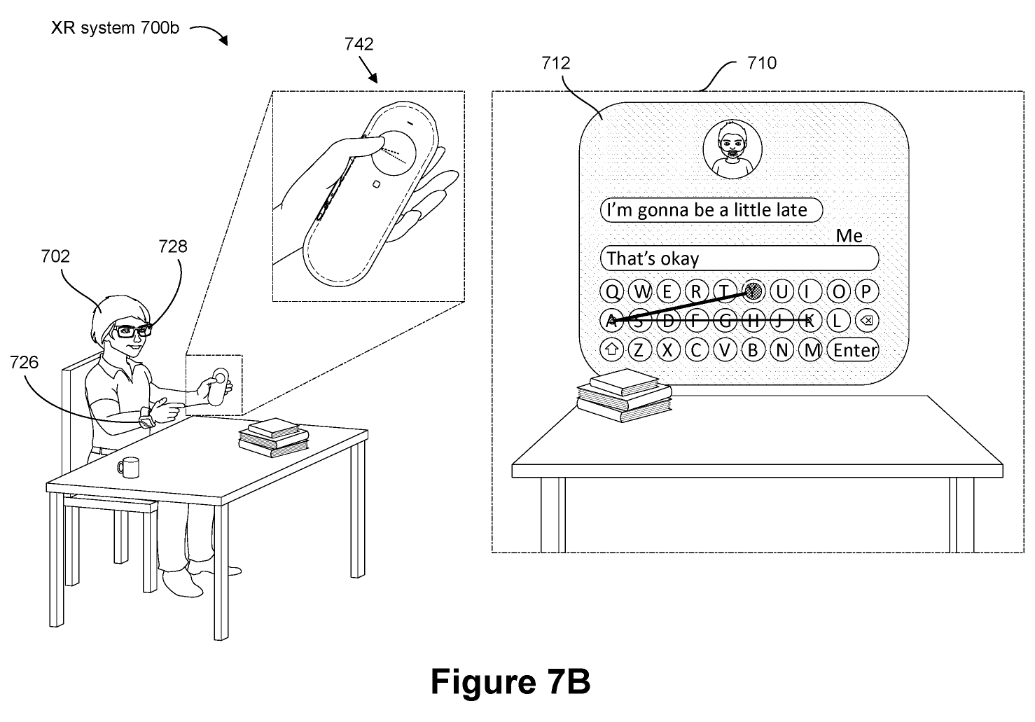

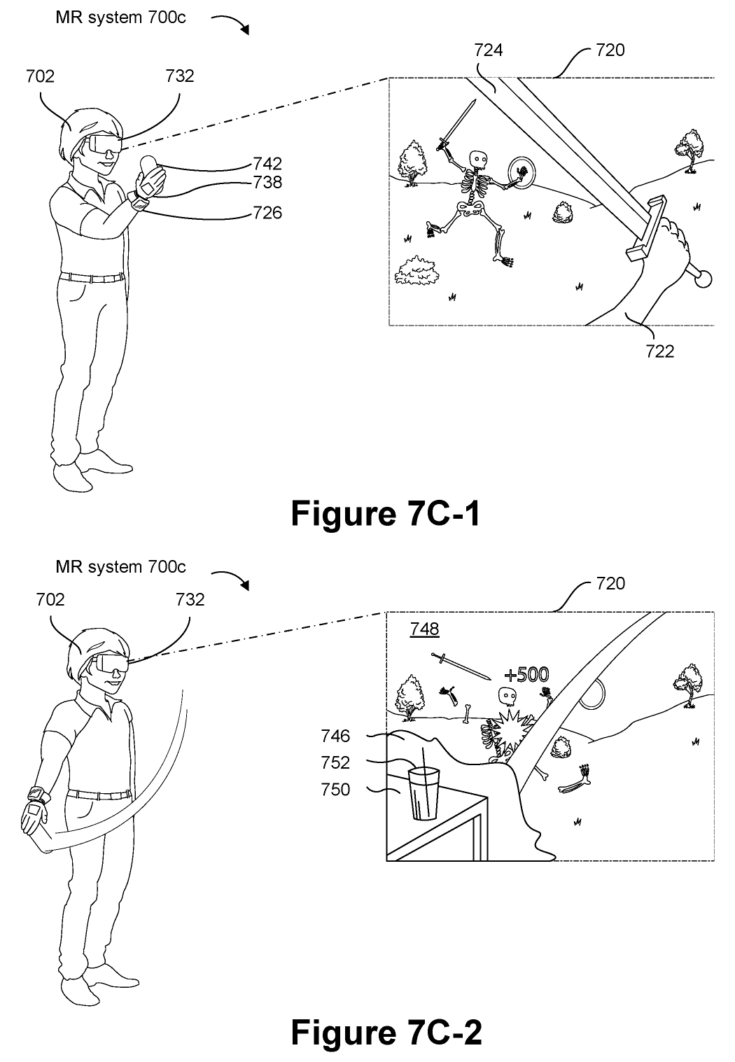

The user 102 in FIG. 1A is wearing a head-wearable device 106 (e.g., an extended-reality headset, AR glasses, smart glasses, etc.) and a wrist-wearable device 104 (e.g., a smartwatch or other type of wristband). In some embodiments, the head-wearable device 106 is an instance of AR device 728 in FIG. 7A and the wrist-wearable device 104 is an instance of wrist-wearable device 738 in FIG. 7A.

In some embodiments, the user 102 is wearing one or more articles of manufacture (e.g., smart shirt 108, smart shorts 110) with one or more integrated sensors configured to detect biopotential data related to the user 102 (e.g., EMG data, ECG data, EEG data, etc.). For example, FIG. 1A illustrates a smart shirt 108 with a plurality of sensors including a cluster of sensors that includes sensors 108a to 108h. In some embodiments, the cluster of sensors 108a to 108h is configured to detect biopotential signals associated with the user 102 such as the user’s heart rate, body temperature, etc. In some embodiments, the wrist-wearable device 104 and the head-wearable device 106 are communicatively coupled to the cluster of sensors 108a-108h and configured to receive the sensor data collected by the cluster of sensors 108a-108h. The sensor data is processed by the wrist-wearable device 104 and/or the head-wearable device 106 and one or more determinations can be made based on the sensor data. For example, if the cluster of sensors 108a-108h detects the user’s body temperature is low, the wrist-wearable device 104 can process the data and recommend to the user 102 to put on a sweater. In some embodiments, the recommendation to the user 102 is displayed in scene 100 at the head-wearable device 106.

In some embodiments, based on the articles of manufacture and other contextual details (e.g., a calendar invitation), the wrist-wearable device 104 and head-wearable device 106 can determine what activity the user 102 will engage in. In some embodiments, the one or more articles of manufacture correspond to at least one activity such as smart running shorts, a smart polo for golf, etc. For example, as illustrated in FIG. 1A, the system can detect smart shirt 108 the user 102 is wearing is a smart polo and that the user 102 usually wears the smart polo when they are playing golf. Further confirmation is included when the wearable devices analyze the user’s calendar and determine the user 102 has a golf appointment. Additional confirmation methods include a reservation email, a text message from another person confirming, etc.

FIG. 1B illustrates the user 102 putting on a wrist band 112 (distinct from the wrist-wearable device 104) based on a recommendation from the AI system (e.g., via a prompt, stating: “Put on your wrist band to increase sensor data detection accuracy”). In some embodiments, the system knows that the user 102 is about to play golf as discussed in FIG. 1A, and based on this determination provides an indication to the user 102 to put on a second article of smart clothing such as the wrist band 112, smart pants, smart jacket, smart socks, etc. In some embodiments, based on the activity and historical data, the system determines additional possible helpful data could be gathered by adding another wearable article of manufacture. For example, FIG. 1B illustrates the AI system suggesting the user put on the wrist band 112 because of the increased accuracy in data the wrist band 112 can gather while the user is performing the activity. For example, the increased accuracy in heart-rate detection during physical exercise can provide the user 102 with a more in-depth analysis. In accordance with some embodiments, the AI system determines that wrist band 112 is required based on a determination that sensors of the wrist-wearable device 104 are incapable of collecting a full range of desired data for a particular activity. For example, the AI system may determine that EMG data from both of the user’s wrists is required for making proper determinations regarding the performance of the activity (e.g., golfing).

In some embodiments, the indication to the user 102 can include a head-wearable device visual indicator 100a displayed at the display of the head-wearable device 106 in scene 100. Additionally, the speakers at the head-wearable device 106 can audibly tell the user 102 the indication (e.g., that the user 102 should stretch before they play golf). In some embodiments, the indication to the user 102 can include a wrist-wearable device visual indicator 114a displayed at the display of the capsule portion 114 of the wrist-wearable device. Additionally, the user 102 can be audibly notified by speakers integrated into the wrist-wearable device 104. Furthermore, the user 102 can receive a notification via haptic feedback or other similar methods.

FIG. 1C shows the user performing an AI-assisted training exercise before performing the predicted activity. In accordance with some embodiments, the AI assistant is configured to provide assistances based on the activity that the user 102 is predicted to perform. FIG. 1C further illustrates the AI assistant guiding the user 102 through one or more stretches configured to prepare the user 102 for their physical activity. In some embodiments, the AI assistant guides the user 102 via prompts at the display of the head-wearable device 106, audibly etc. Additionally, the AI assistant receives data gathered and generated by the smart shirt 108, smart shorts 110, and wrist band 104 and 112 which provide data to the AI assistant which enables to the AI assistant to perform assistive tasks. For example, the AI assistant recommends one or more exercises based on the activity, needs of the specific user (e.g., user 102), and considering historical data (e.g., previous times the user 102 performed the warm up). FIG. 1C further illustrates the AI assistant recommending one or more stretching exercises configured to help the user 102 warm up. The AI assistant can also recommend other types of preparation include hitting a certain number of golf balls, performing some light cardio, etc. such that the user 102 is in the best shape to play. The AI assistant also uses historical data based on the user’s past performance that will impact how the AI assistant suggests recommendations. For example, if the user 102 did too much cardio before their golf game last time and that impacted their performance, the AI assistant can adjust the amount of cardio for the warm up.

In another example, if the user 102 is preparing for another activity like soccer, the AI assistant will recommend stretches and warm up routines specific to streamline and prepare the user 102 to the fullest extent. For example, the wearable articles of manufacture can determine different biological responses such as body temperature, HR, etc. Such that, while the user 102 is warming up or playing, the AI assistant might measure that the user 102 is sweating too much and is insufficiently replenishing their fluids, or the user’s heart rate is staying too high, and they are not getting enough rest between plays. Additionally, sensors integrated into the one or more articles of manufacture are configured to sense a variety of biopotential signals configured to provide the AI assistant with a plurality of data points to make determinations on the user’s 102 status and performance.

FIG. 1D shows the user 102 donning a wearable article of manufacture based on an AI indication that the additional wearable article of manufacture would improve the user’s performance at the predicted activity. For example, the AI system may determine based on the user’s training exercise, that the additional wearable article of manufacture would improve the user’s ability to perform the activity. FIG. 1D further illustrates the AI assistant recommending the user 102 via head-wearable device indication 110b to put on their smart jacket 116 to increase positive performance. In some embodiments, based on historical data and/or current sensor readings from the wearable articles of manufacture, the AI assistant deduces that when the user’s 102 muscles get cold during golf, the user’s performance declines. For example, the smart shorts 110 can detect the user’s body temperature based on either the cluster of sensors 110a to 110e (e.g., averaging the temperature of each respective sensor) or on one individual sensor (e.g., sensor 110b). Thus, based on the sensor data gathered by the wearable articles of manufacture, the AI assistant determines the recommendations configured to enhance the user’s performance. In some embodiments, the recommendation is proactive and based on historical data and current user sensor data. For example, if the outside temperature is predicted to drop below a predetermined threshold (e.g., lower than 65 degrees F), and in the past the user’s performance has declined due to temperatures below the predetermined threshold, the AI system proactively recommends to the user 102 to put on the smart jacket 116.

FIG. 1D further illustrates the smart jacket 116 coupling to the wrist band 112. In some embodiments, the coupling between the two wearable articles of manufacture allows them to exchange data (e.g., the wrist band 112 receiving sensor data from the smart jacket 116) and/or enables the smart jacket 116 to charge based on power provided by the wrist-wearable device. In some embodiments, the coupling includes magnetic and/or via wireless communication (e.g., Wi-Fi, Bluetooth, induction, etc.).

FIG. 1E shows the user performing the predicted activity (e.g., playing golf) and the AI system providing information to the user at the scene 100 indicating relevant aspects about the activity that the user 102 is performing. In accordance with some embodiments, the information provided via the head-wearable device indication 100c at the scene 100 is based on behavioral and/or historical data about the user 102. The head-wearable device indication 100c includes information provided to the user 102 based on sensor data generated by the one or more sensors integrated into the wearable articles of manufacture (e.g., smart jacket 116, smart shorts 110, and smart shirt 108). In some embodiments, the information includes information relevant to the predicted activity such as the external temperature, wind speed, GPS location, distance to the next hole, etc.

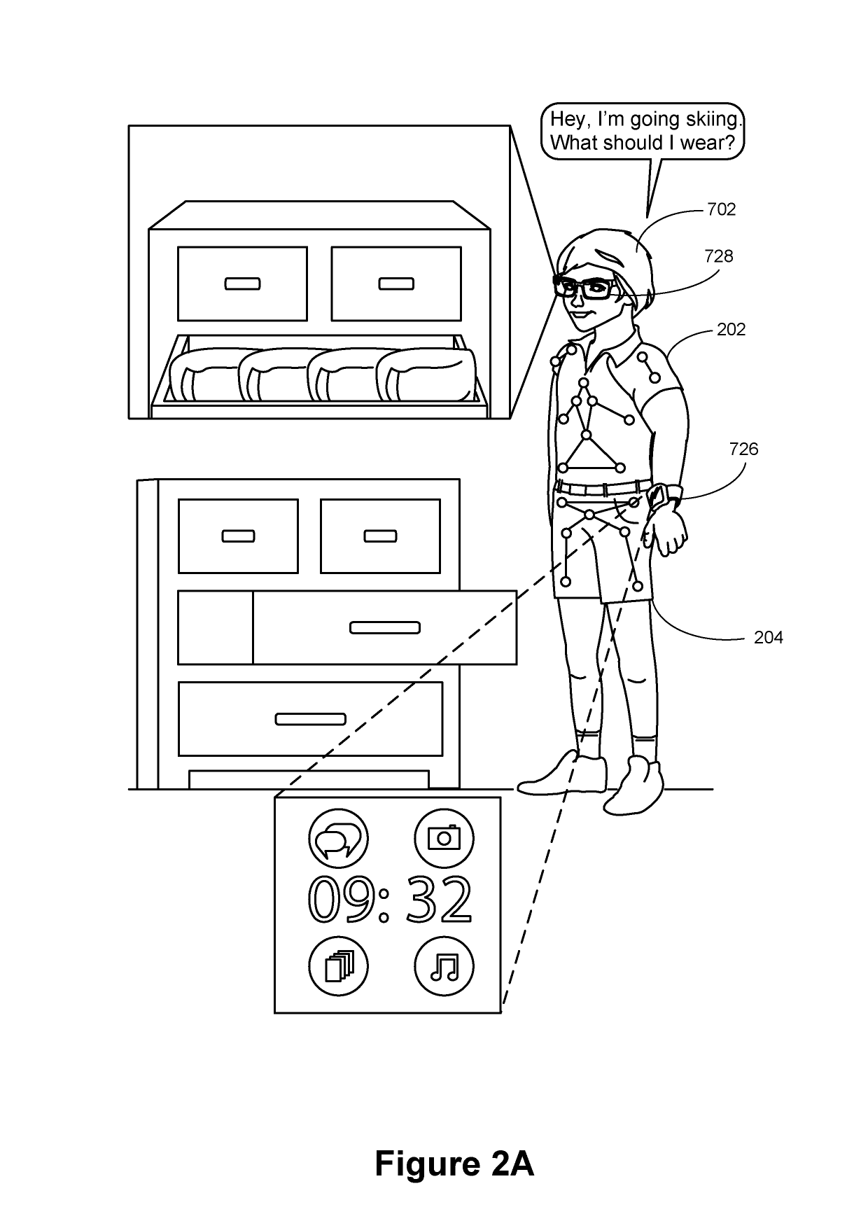

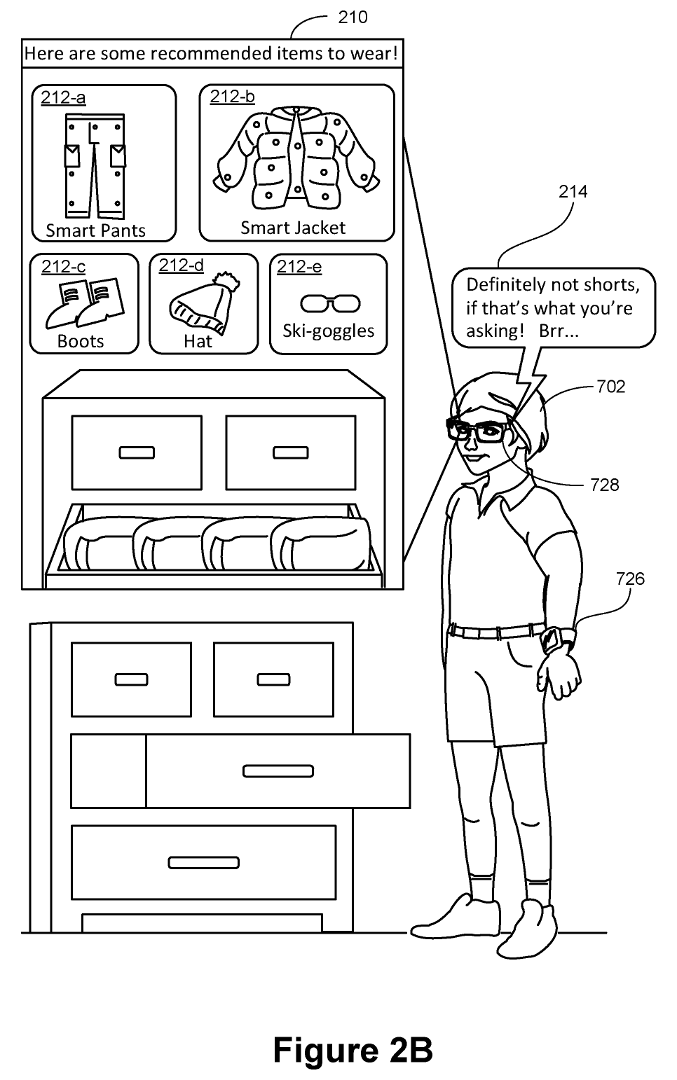

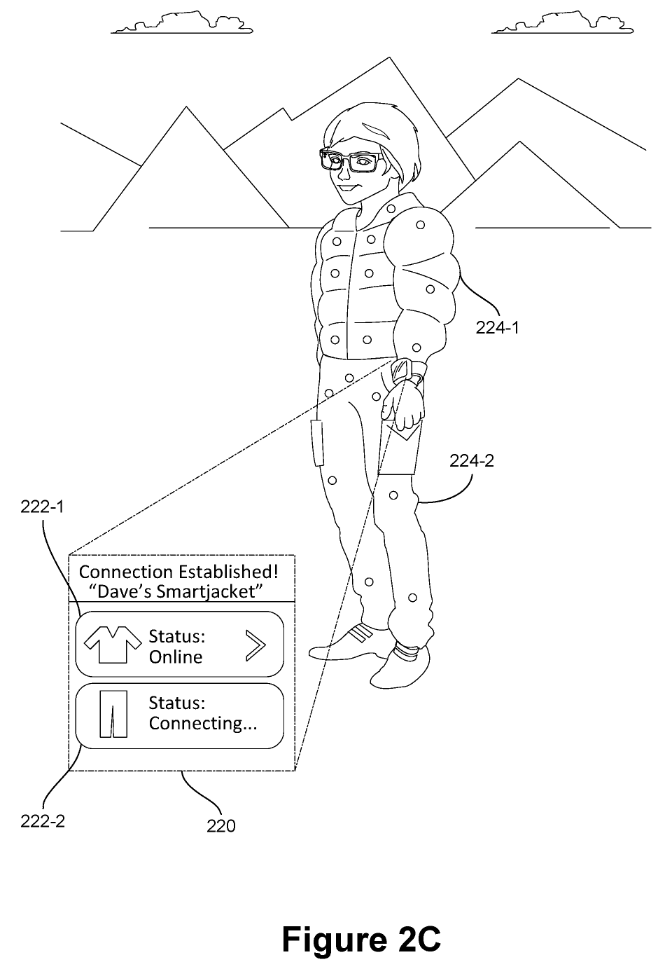

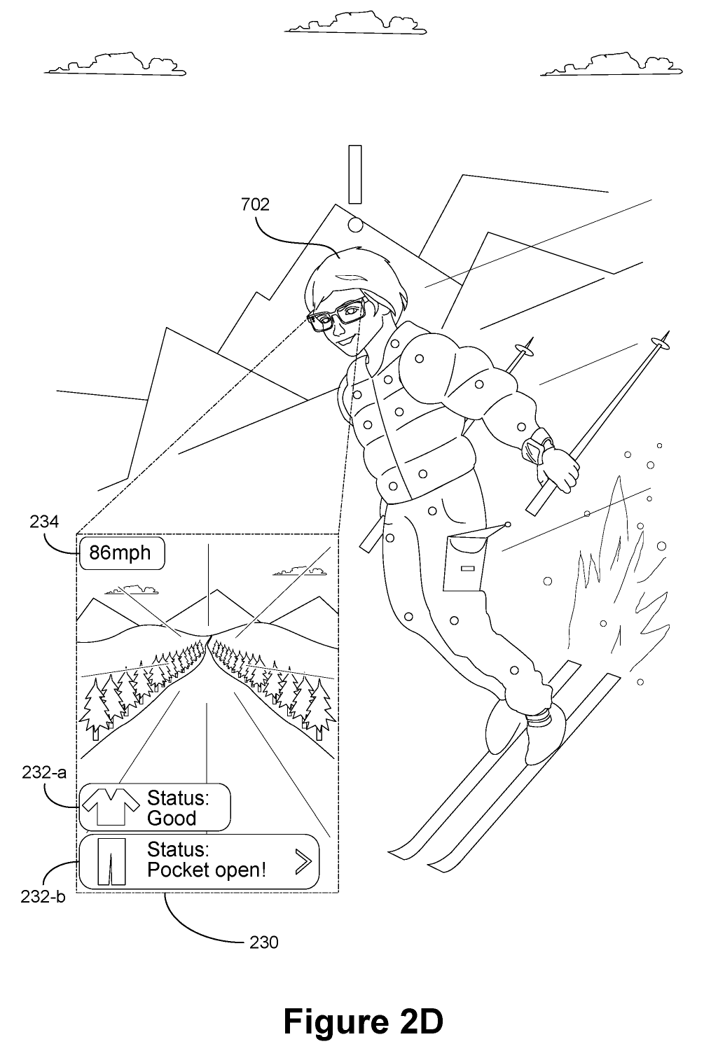

FIGS. 2A to 2D illustrate a second example of an AI system providing recommendations to a user about wearable articles of manufacture based on interactions by the user with the AI systems, in accordance with some embodiments.

FIG. 2A shows a user interacting with an AI system, which may be associated with either the AR glasses 728, the wrist-wearable device 726, or another electronic device that is in electronic communication with the user. The user is wearing a set of wearable articles of manufacture including a sensor-laden shirt 202 and a sensor-laden pair of shorts 204.

FIG. 2B shows a user interface 210 being presented as a result of the prompt provided by the user in FIG. 2A. The user interface 210 includes a plurality user interface elements 212 (e.g., a smart pants recommendation user interface element 212-a, a smart jacket recommendation user interface element 212-b, a winter boots recommendation user interface element 212-c, a hat recommendation user interface element 212-d, and a smart goggles recommendation 212-e) based on the prompt that the user provided to the AI model in FIG. 2A. The AI model also provides an audio response 214 to the user (e.g., “Definitely not shorts, if that is what you are asking! Brr…”), in accordance with some embodiments.

FIG. 2C shows the user after donning respective wearable articles of manufacture suggested in FIG. 2B (e.g., a smart jacket 224-1, a pair of smart pants 224-2). A user interface 220 is being presented (e.g., at the wrist-wearable device 726) that includes respective status indicators, which are indicating whether the respective devices are online (e.g., a first user interface element 222-1 indicating a connectivity status of the sensor-laden shirt, and a second user interface element 222-2 indicating a connectivity status of the sensor-laden pants). In accordance with some embodiments, if there is a connectivity issue with a particular wearable article of manufacture being worn by the user, the AI system may determine whether there are other wearable articles of manufacture being worn by the user that can provide any similar capabilities. In accordance with some embodiments, if the AI system determines that there are no available wearable articles of manufacture to replace the wearable article that is having the connectivity issues, the AI system may provide a recommendation to the user to don another wearable article of manufacture to resolve the issues and/or an indication of what services may not be available if the connectivity issue is not resolved.

FIG. 2D shows the user engaging in the predicted activity (e.g., skiing) after the user has donned the recommended articles of manufacture, including the smart jacket and the smart pants shown in the user interface 210. A user interface 230 is being presented by the user’s smart glasses that includes information related to the activity that the user is performing, including an activity indicator user interface element 234 (e.g., an indication of the speed that the user is skiing), as well as indications as to aspects of the wearable articles of manufacture that the user is wearing, in accordance with some embodiments.

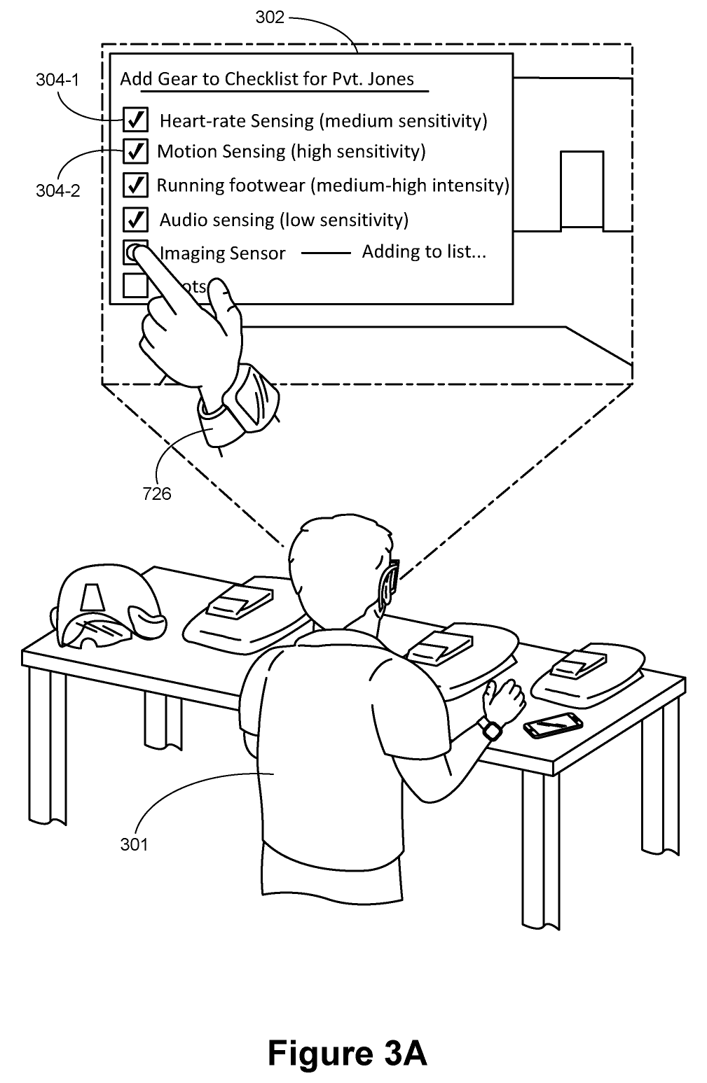

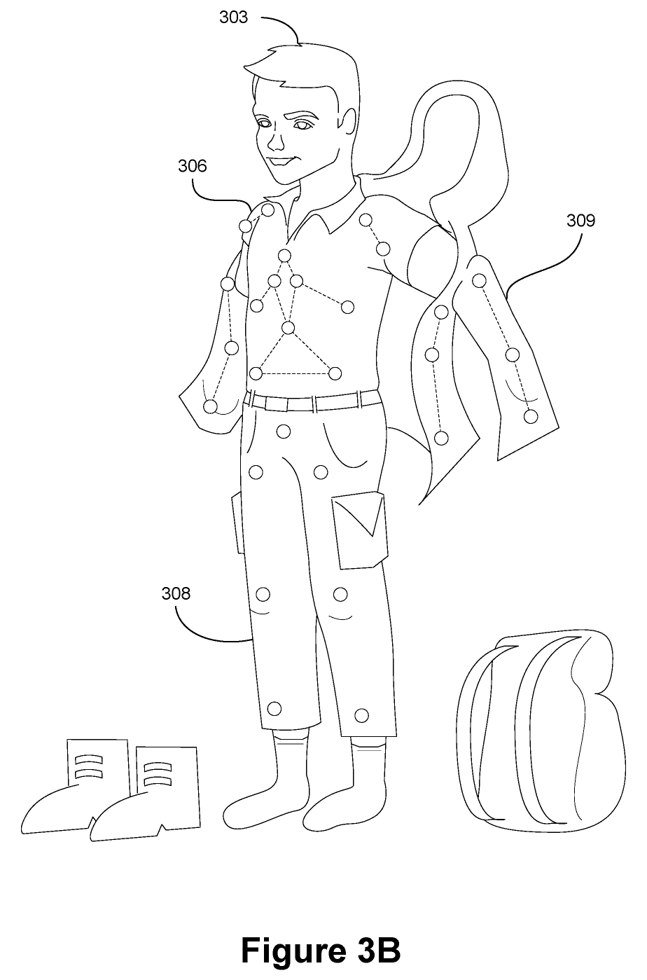

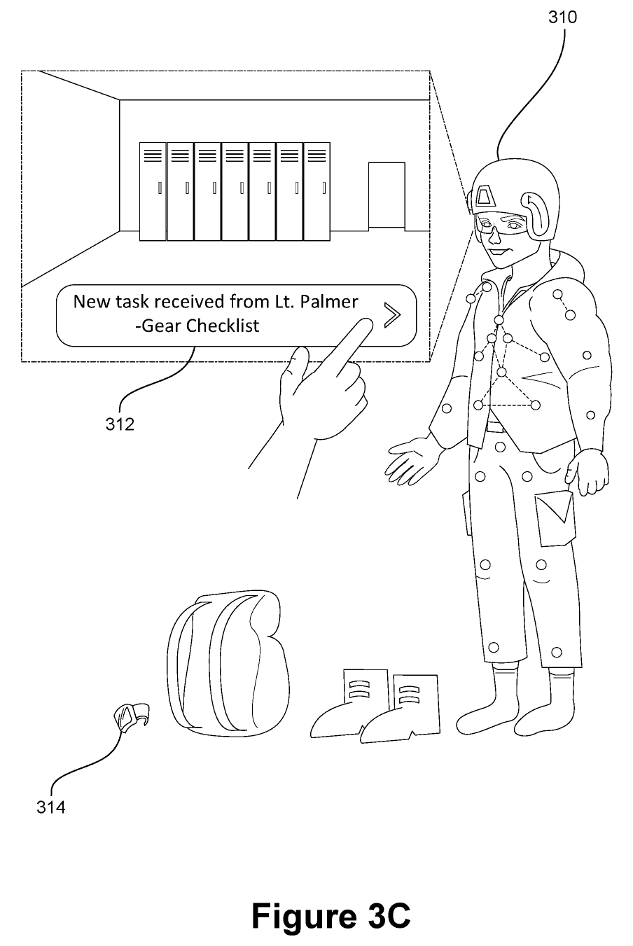

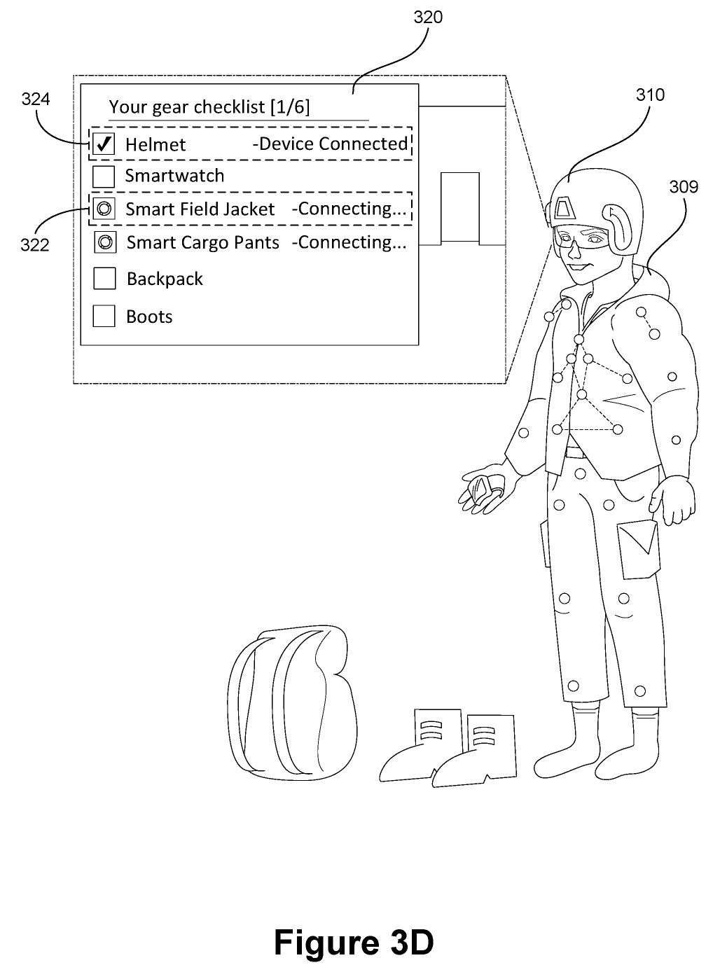

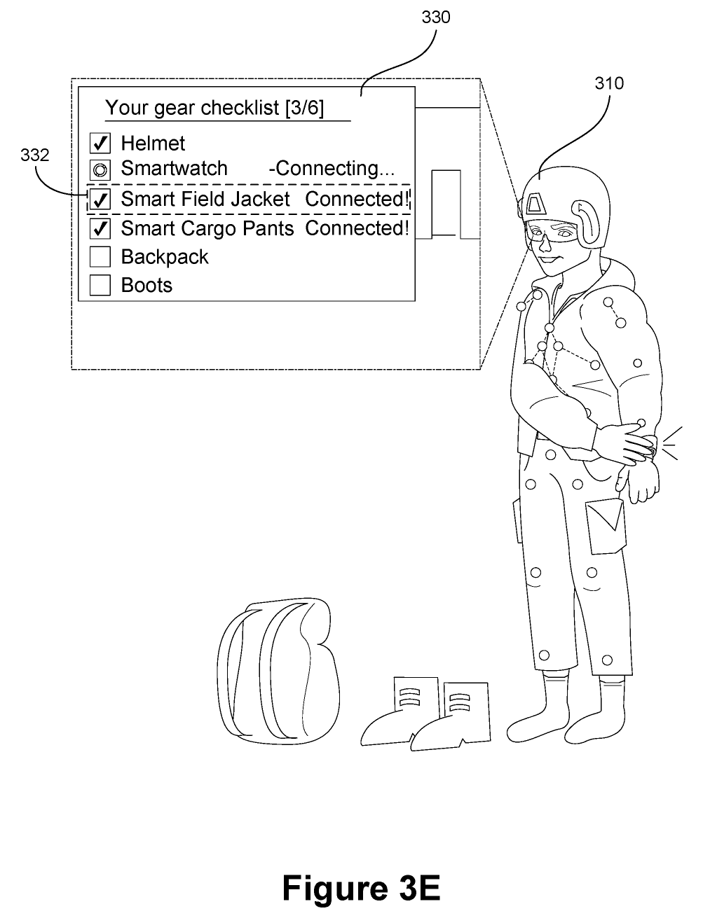

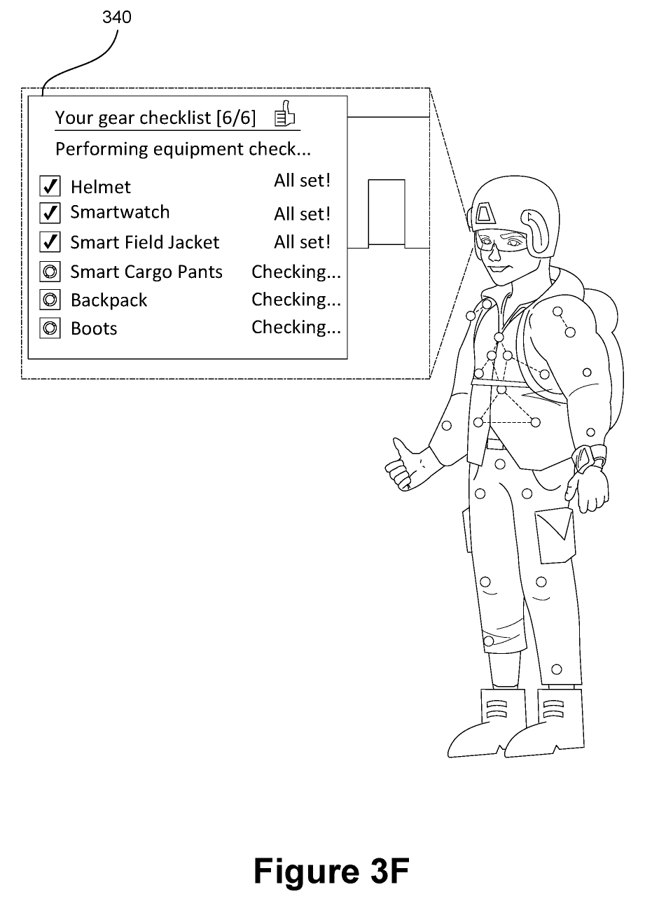

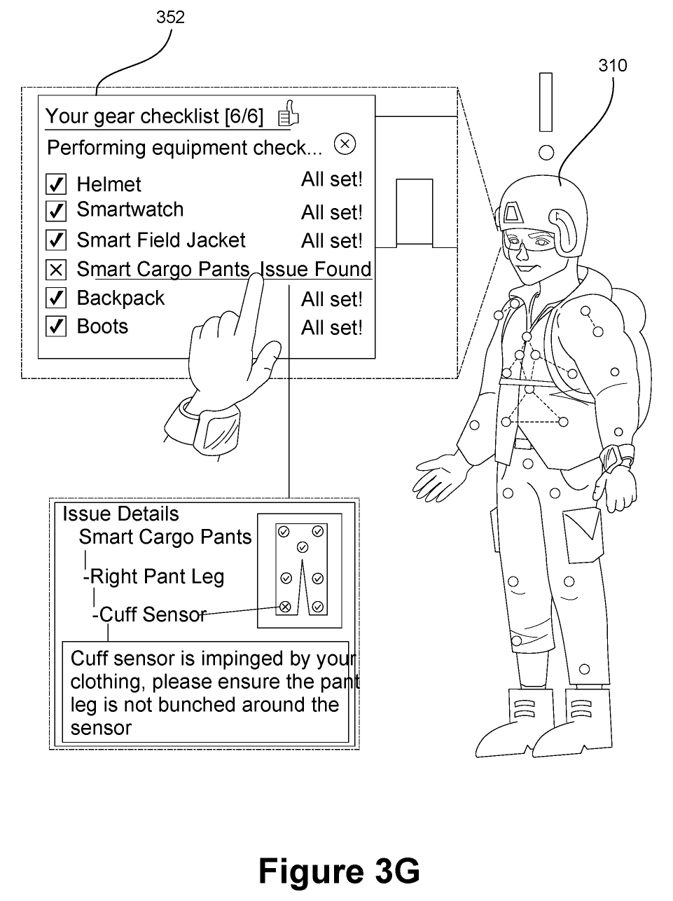

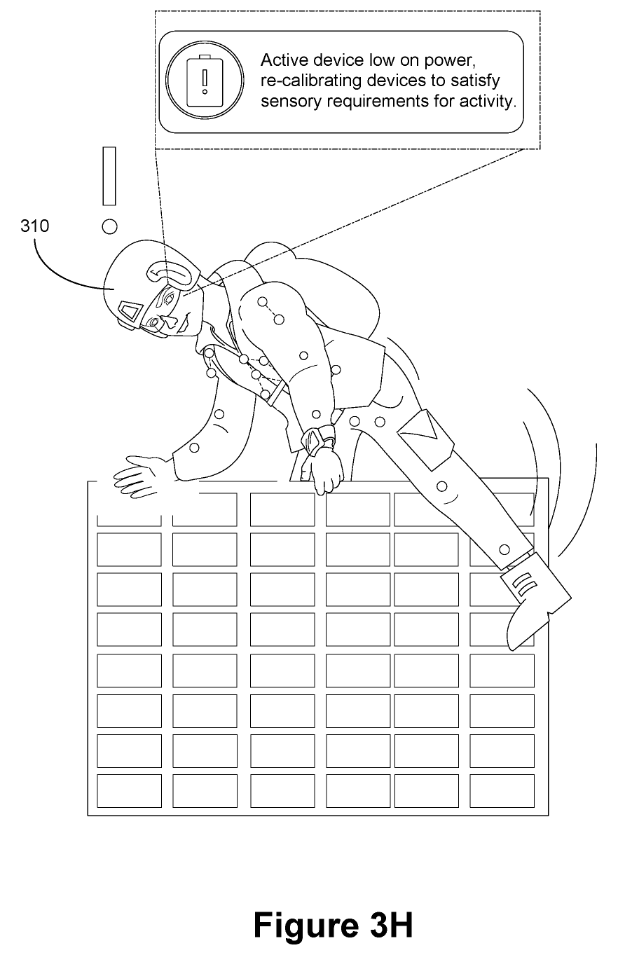

FIGS. 3A to 3H illustrate an example of users interacting with an AI system to determine and comply with usage requirements for an AI system during the performance of a set of military operations, in accordance with some embodiments.

FIG. 3A shows a first user (e.g., an officer leading a unit of soldiers) setting usage requirements based on a set of usage requirements for one or more military operations to be performed by a group of other users. The user is wearing a set of AR glasses that is presenting a user interface 302 for selecting requirements that will be required by the group of other users. For example, the user interface includes a first user interface element 304-1 indicating a heart-rate sensing requirement and a second user interface element 304-2 indicating a motion-sensing requirement. In some embodiments, the requirement options are pre-populated by an AI model. In some embodiments, the requirement options are determined by a set of military operations that are set to be performed using the set of wearable military gear.

FIG. 3B shows another user 303 donning equipment based on a received indication regarding the set of usage requirements determined in FIG. 3A. The user is wearing a sensor-laden shirt 306 a sensor-laden pants 308, and a smart jacket 309, in accordance with some embodiments. In some embodiments, one or more devices that associated with the user can provide an indication that a requirement of the set of requirements shown in FIG. 3A is satisfied.

FIG. 3C shows the user 303 receiving a message at the AR helmet 310 regarding updates to the usage requirements for the set of military operations that the user 303 is preparing to perform. In some embodiments, the wrist-wearable device 314 is also configured to present user interfaces to the user 303 that would otherwise be received at the AR helmet 310. The user’s AR helmet 310 has a display component which is displaying a user interface element 312 indicating that there is an update regarding the equipment requirements (e.g., “New task received from Lt. Palmer -Gear Checklist”).

FIGS. 3D - 3F show the user 309 donning equipment while the equipment checklist from the user interface 302 in FIG. 3A is being presented at the AR helmet 310 via the user interface 320. The user interface 320 includes indication (e.g., a first indication 322, a second indication 324) which can be used to indicate whether respective equipment requirements are satisfied based on the set of requirements established in FIG. 3A.

FIGS. 3G and 3H show indications being provided to the user while the user is performing activities of the set of military operations of which the set of equipment requirements are based.

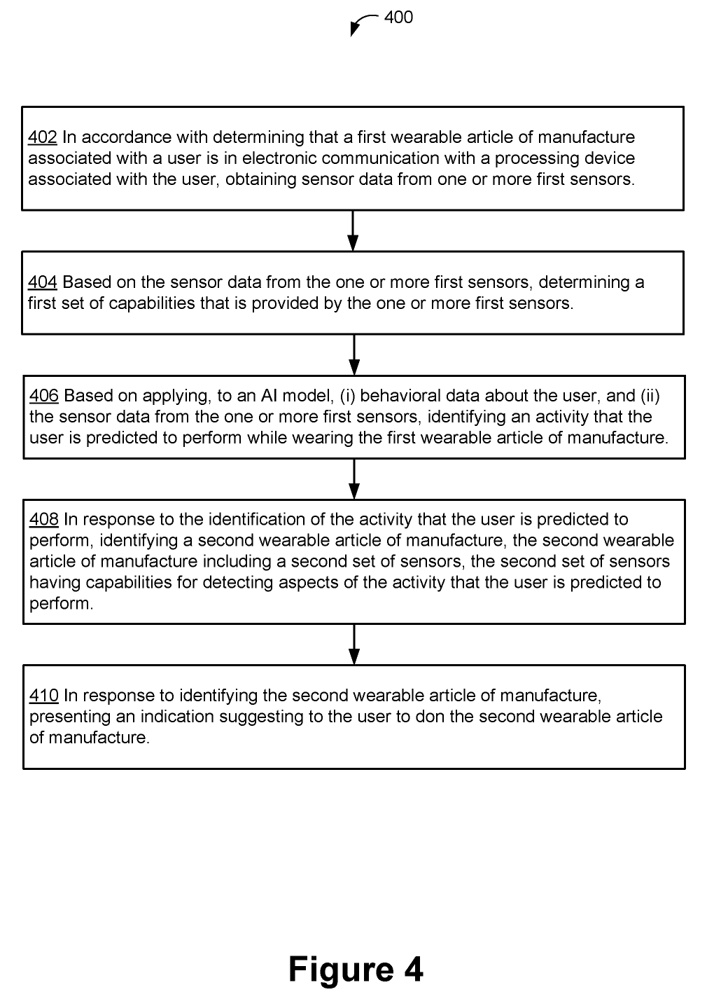

FIG. 4 shows an example method flow chart for intelligently recommending sensor-laden articles of manufacture to a user based on activities that a user is predicted to perform, in accordance with some embodiments. Operations (e.g., steps) of the method 400 can be performed by one or more processors (e.g., central processing unit and/or MCU) of a system 700a. At least some of the operations shown in FIG. 4 correspond to instructions stored in a computer memory or computer-readable storage medium (e.g., storage, RAM, and/or memory). Operations of the method 400 can be performed by a single device alone or in conjunction with one or more processors and/or hardware components of another communicatively coupled device (e.g., HIPD 742 in FIG. 7A) and/or instructions stored in memory or computer-readable medium of the other device communicatively coupled to the system 700a. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.

(A1) The method 400 includes, in accordance with determining that a first wearable article of manufacture associated with a user (e.g., a wearable device, a sensor-laden garment) is in electronic communication with a processing device associated with the user, obtaining (402) sensor data from one or more first sensors. For example, as shown in FIG. 1A, the smart jacket 108 worn by the user 102 includes sensors 108a-108h that provide sensor data to the wrist-wearable device 104 and/or head-wearable device 106.

The method 400 includes, based on the sensor data from the one or more first sensors, determining (404) a first set of capabilities (e.g., a first user interaction space) that is provided by the one or more first sensors. In some embodiments, the sensor data itself is analyzed to determine the capabilities provided by the sensors. For example, the system may identify sensor types based on data characteristics present in the sensor data (e.g., identifying EMG data based on signal frequency patterns, identifying accelerometer data based on motion-related signal profiles), determine operational status of sensors based on signal quality metrics in the sensor data, and/or infer sensing capabilities from data patterns observed in the sensor data.

In some embodiments, determining the first set of capabilities includes cataloging sensor types present in the first wearable article of manufacture and mapping each sensor type to corresponding detection capabilities. For example, EMG sensors may provide muscle activity detection capabilities, ECG sensors may provide cardiac rhythm detection capabilities, temperature sensors may provide body temperature monitoring capabilities, and motion sensors (e.g., accelerometers, gyroscopes) may provide movement tracking capabilities. In some embodiments, the system maintains a capability registry that associates each sensor type with a predefined set of capabilities, and the determining step includes querying the capability registry based on the identified sensor types. In some embodiments, the first set of capabilities is further determined based on a sensor density of the first wearable article of manufacture, wherein a higher sensor density provides enhanced spatial resolution for detecting localized physiological signals. For example, as shown in FIG. 1A, the cluster of sensors 108a-108h distributed across the smart jacket 108 provides capabilities for detecting biopotential signals such as heart rate and body temperature, and the density of the sensors 108a-108h along the torso region enables detection of cardiac activity with greater accuracy than a single sensor placement.

In some embodiments, the system evaluates whether the current sensor density meets a threshold density required for a particular type of activity detection. In some embodiments, the system maps sensor density values to corresponding capability levels, wherein a first density range corresponds to a first capability level and a second density range corresponds to a second capability level. For example, the system may determine that a sensor density of less than one sensor per ten square centimeters provides basic motion detection capabilities, a sensor density of one to three sensors per ten square centimeters provides intermediate capabilities including gross muscle group activation detection, and a sensor density of greater than three sensors per ten square centimeters provides advanced capabilities including fine motor movement detection and individual muscle fiber activation detection. In some embodiments, the inter-sensor spacing determines what types of physiological signals can be reliably detected, wherein smaller inter-sensor spacing enables detection of localized signals that would be averaged out or undetectable with larger inter-sensor spacing. For example, detecting individual finger muscle activations may require sensors spaced less than two centimeters apart, whereas detecting overall arm movement may be achievable with sensors spaced ten centimeters apart. In some embodiments, the system uses sensor density metrics in combination with sensor type information to generate a capability profile for the first wearable article of manufacture, wherein the capability profile specifies which activities can be monitored and at what level of detail.

The method 400 includes, based on applying, to an AI model, (i) behavioral data about the user, and (ii) the sensor data from the one or more first sensors, identifying (406) an activity that the user is predicted to perform while wearing the first wearable article of manufacture. In some embodiments, the AI model is configured to process the behavioral data and the sensor data as complementary inputs that together enable more accurate activity prediction than either input alone. For example, the behavioral data may indicate that the user has a calendar appointment for golf at 2:00 PM, while the sensor data from the first wearable article of manufacture may indicate elevated heart rate and specific body positioning consistent with pre-activity preparation. The AI model correlates these dual inputs to confirm the predicted activity with higher confidence than would be achievable using only the behavioral data or only the sensor data. In some embodiments, the AI model applies a weighting function that adjusts the relative influence of the behavioral data and the sensor data based on the type of activity being predicted. For example, for activities that are typically scheduled (e.g., golf, tennis), the behavioral data may be weighted more heavily, whereas for spontaneous activities (e.g., jogging, stretching), the real-time sensor data may be weighted more heavily. In some embodiments, the AI model includes a temporal correlation component that analyzes patterns in the sensor data over time and compares those patterns to historical activity patterns stored in the behavioral data to identify the predicted activity.

The method 400 includes, in response to the identification of the activity that the user is predicted to perform, identifying (408) a second wearable article of manufacture, the second wearable article of manufacture including a second set of sensors, the second set of sensors having capabilities for detecting aspects of the activity that the user is predicted to perform. For example, as shown in FIGS. 1A-1D, the AI system identifies that the user 102 is predicted to play golf and recommends the jacket portion 116 as shown in the display 100 of FIG. 1D.

In some embodiments, identifying the second wearable article of manufacture includes: (i) determining a set of required sensing capabilities for the predicted activity, (ii) comparing the first set of capabilities provided by the one or more first sensors to the set of required sensing capabilities, (iii) identifying a capability gap between the first set of capabilities and the set of required sensing capabilities, and (iv) selecting the second wearable article of manufacture from a database of available wearable articles based on a determination that the second set of sensors of the second wearable article of manufacture addresses the identified capability gap. For example, if the predicted activity is golf, the set of required sensing capabilities may include arm motion tracking, torso rotation detection, and grip pressure sensing.

In some embodiments, if the first wearable article of manufacture (e.g., smart jacket 108) provides torso rotation detection but lacks arm motion tracking and grip pressure sensing, the system identifies the capability gap and selects a second wearable article of manufacture (e.g., smart gloves or wristbands) that includes sensors capable of arm motion tracking and grip pressure sensing. In some embodiments, the system maintains a database that associates each available wearable article of manufacture with its corresponding sensor capabilities, and the identifying step includes querying the database to find wearable articles that satisfy the capability gap. In some embodiments, the system ranks multiple candidate wearable articles based on how well each candidate addresses the capability gap, and selects the highest-ranked candidate as the second wearable article of manufacture. The ranking may be based on a multi-factor scoring algorithm that evaluates candidates according to: (i) capability coverage indicating how completely the candidate addresses the gap, (ii) sensor quality based on accuracy and precision, (iii) power efficiency relative to the anticipated activity duration, (iv) comfort based on user preferences or historical usage patterns, and (v) compatibility with wearable articles already being worn. In some embodiments, different activities may weight these factors differently; for example, athletic activities may weight sensor quality more heavily, while extended-duration activities may weight power efficiency and comfort more heavily. In some embodiments, the system includes a machine learning component that refines the ranking algorithm based on past selections and user feedback. When multiple candidates have similar scores, the system may consider user preference history, article availability or proximity, or present a ranked list to the user via the display 100 (as shown in FIG. 1B) or the recommendation display 210 (as shown in FIG. 2B) for user selection.

In some embodiments, the system maintains an activity-sensor mapping database that associates each of a plurality of activities with corresponding required sensing capabilities. The activity-sensor mapping database may include entries such as: (i) golf – requiring arm motion sensors, torso rotation sensors, grip pressure sensors, and heart rate sensors; (ii) running – requiring leg motion sensors, foot strike sensors, heart rate sensors, and GPS sensors; (iii) cycling – requiring leg motion sensors, cadence sensors, heart rate sensors, and GPS sensors; (iv) swimming – requiring stroke detection sensors, heart rate sensors, and lap counting sensors; and (v) weightlifting – requiring muscle activation sensors, repetition counting sensors, and heart rate sensors. In some embodiments, the activity-sensor mapping database is updated based on user feedback and historical performance data. For example, if a user consistently achieves better performance metrics when wearing a particular combination of wearable articles for a particular activity, the system may update the activity-sensor mapping database to reflect the preferred sensor configuration for that activity. In some embodiments, the activity-sensor mapping database includes activity-specific sensor placement recommendations. For example, for golf, the database may indicate that arm motion sensors should be positioned on both the lead arm and the trail arm to capture the full swing motion, and that torso rotation sensors should be positioned along the spine to capture rotation through the swing plane.

The method 400 includes, in response to identifying the second wearable article of manufacture, presenting (410) an indication suggesting to the user to don the second wearable article of manufacture. In some embodiments, the system employs a multi-stage process for identifying the second wearable article of manufacture. The process may include: (i) querying a database of available wearable articles using the predicted activity as a search parameter; (ii) filtering candidates based on sensor type matching to retain articles with sensors capable of detecting aspects of the predicted activity; (iii) analyzing body region coverage to prioritize candidates that provide sensor coverage for regions not covered by the first wearable article; (iv) checking real-time availability, including proximity to the user, charge status, and whether the article is currently worn by another user; and (v) selecting the second wearable article from the filtered candidates. When multiple candidates remain, the system may select based on highest capability coverage score or present options to the user via the display 100 or recommendation display 210. When no candidate satisfies all criteria, the system may relax one or more criteria, or present an indication that no suitable article is available along with suggestions for alternative actions.

(A2) In some embodiments of A1, the one or more first sensors are distributed along a skin-facing surface of the first wearable article of manufacture. Positioning the sensors along the skin-facing surface enables direct detection of biopotential signals generated by the user's body, such as EMG signals from muscle contractions, ECG signals from cardiac activity, and galvanic skin response signals indicative of perspiration levels. In some embodiments, the skin-facing positioning of the sensors reduces signal noise and improves signal fidelity compared to sensors positioned on an outward-facing surface of the wearable article of manufacture. In some embodiments, the sensors are arranged in a predetermined pattern along the skin-facing surface to optimize detection of specific biopotential signals based on the predicted activity. For example, for activities involving upper body movement (e.g., golf, tennis), the sensors may be concentrated along the skin-facing surfaces of the arm and shoulder regions to capture muscle activity data relevant to swing mechanics. For activities involving lower body movement (e.g., running, cycling), the sensors may be concentrated along the skin-facing surfaces of the leg regions to capture muscle activity data relevant to stride analysis. For example, as shown in FIG. 1A, the sensors 108a-108h of the smart jacket 108 are positioned along the torso area of the garment in contact with the skin of the user 102, enabling detection of heart rate, respiration rate, and torso muscle activity during physical activities.

In some embodiments, the method includes, based on applying, to an AI model, (i) behavioral data about the user, and (ii) the sensor data from the one or more first sensors as complementary inputs, identifying an activity that the user is predicted to perform while wearing the first wearable article of manufacture. For example, the behavioral data may include calendar data indicating a scheduled golf session, historical activity patterns showing the user frequently plays golf on weekend mornings, or user-specified preferences for outdoor activities. The sensor data from the one or more first sensors may include motion data from IMUs of a wrist-wearable device 104 or biopotential signals from EMG sensors distributed along the smart jacket 108, as described above with reference to FIG. 1A. In some embodiments, the AI model correlates the behavioral data and the sensor data to identify the activity with higher confidence than would be achievable using only the behavioral data or only the sensor data. For example, the AI model may determine that the user is preparing for a golf activity based on a combination of calendar data indicating a tee time and sensor data indicating the user is performing warm-up stretches consistent with golf preparation. As described above with reference to FIGS. 1C-1E, the identified activity may be used to recommend additional sensor-laden wearable articles of manufacture having capabilities for detecting aspects of the predicted activity.

(A3) In some embodiments of A1 or A2, the first set of capabilities that is provided by the one or more first sensors relates to a sensor density (e.g., an amount of distance between respective sensors of the one or more first sensors) of the wearable article of manufacture. In some embodiments, a higher sensor density provides enhanced spatial resolution for detecting localized physiological signals, enabling more precise activity analysis. For example, a high sensor density along the arm region of a wearable article of manufacture may enable detection of individual muscle group activations during a golf swing, whereas a lower sensor density may only enable detection of overall arm movement. In some embodiments, the system evaluates whether the sensor density of the first wearable article of manufacture meets a density threshold required for the predicted activity. If the sensor density is below the density threshold, the system may identify a second wearable article of manufacture with a higher sensor density in the relevant body region. In some embodiments, different activities are associated with different density thresholds. For example, activities requiring fine motor control analysis (e.g., golf putting, archery) may be associated with higher density thresholds than activities requiring gross motor movement analysis (e.g., jogging, walking). For example, as shown in FIG. 1A, the cluster of sensors 108a-108h on the smart jacket 108 demonstrates sensor density through the spacing between adjacent sensors along the garment, and the system may determine that this sensor density is sufficient for detecting torso rotation during a golf swing but insufficient for detecting fine wrist movements, thereby prompting a recommendation to don a wrist-wearable device with higher sensor density.

(A4) In some embodiments of any one of A1 to A3, the behavioral data about the user is not based on an external environment of the user (e.g., weather conditions, surrounding terrain, etc.). For example, as shown in FIG. 1A, the behavioral data may include the user 102's calendar appointments or historical activity patterns rather than weather conditions.

(A4a) In some embodiments, identifying the second wearable article of manufacture includes determining a set of required sensing capabilities for the identified activity, comparing the first set of capabilities to the set of required sensing capabilities to identify a capability gap, and selecting the second wearable article of manufacture based on a determination that the second set of sensors addresses the identified capability gap. For example, as illustrated in FIGS. 1C and 1D, when the user 102 is predicted to perform a golf activity, the system may determine that motion sensing at the torso is required for swing analysis. If the user 102 is currently wearing only the wrist-wearable device 104, the system may identify a capability gap related to torso motion detection and select the smart jacket 108 with its distributed sensors 110 (e.g., sensors 110a-110g as shown in FIG. 1D) to address this gap and provide comprehensive swing tracking capabilities.

(A4b) In some embodiments, selecting the second wearable article of manufacture includes querying a database that associates each of a plurality of available wearable articles of manufacture with corresponding sensor capabilities. For example, as shown in FIG. 2A, when the user 702 requests assistance from an AI agent regarding what to wear for skiing, the system may query a database to identify available wearable articles such as the smart pants 212-a, smart jacket 212-b, boots 212-c, hat 212-d, and ski goggles 212-e (e.g., FIG. 2B), each associated with respective sensor capabilities suitable for the predicted skiing activity.

(A5) In some embodiments of any one of A1 to A4b, the method 400 includes, in accordance with identifying the second wearable article of manufacture, suggesting a modification to the activity that the user is predicted to perform. For example, as shown in FIG. 1C, the AI assistant may suggest warm-up exercises or stretches to modify how the user 102 prepares for the predicted golf activity.

(A6) In some embodiments of any one of A1 to A5, the method 400 includes determining, based on previous activity data, that the second wearable article of manufacture is more suitable for use with the one or more first sensors of the first wearable article of manufacture. For example, as shown in FIGS. 1A-1D, the system determines based on previous golf sessions that the jacket portion 116 is more suitable for use with the sensors 108a-108h of the smart jacket 108.

(A7) In some embodiments of A6, the second wearable article of manufacture is determined to be more suitable with the one or more first sensors of the first wearable article of manufacture based on a determination that the second wearable article of manufacture increases sensing capabilities of the one or more first sensors. For example, as shown in FIG. 1D, the jacket portion 116 with sensors 110a-110g increases the sensing capabilities of the smart jacket 108 by providing additional temperature and motion detection coverage.

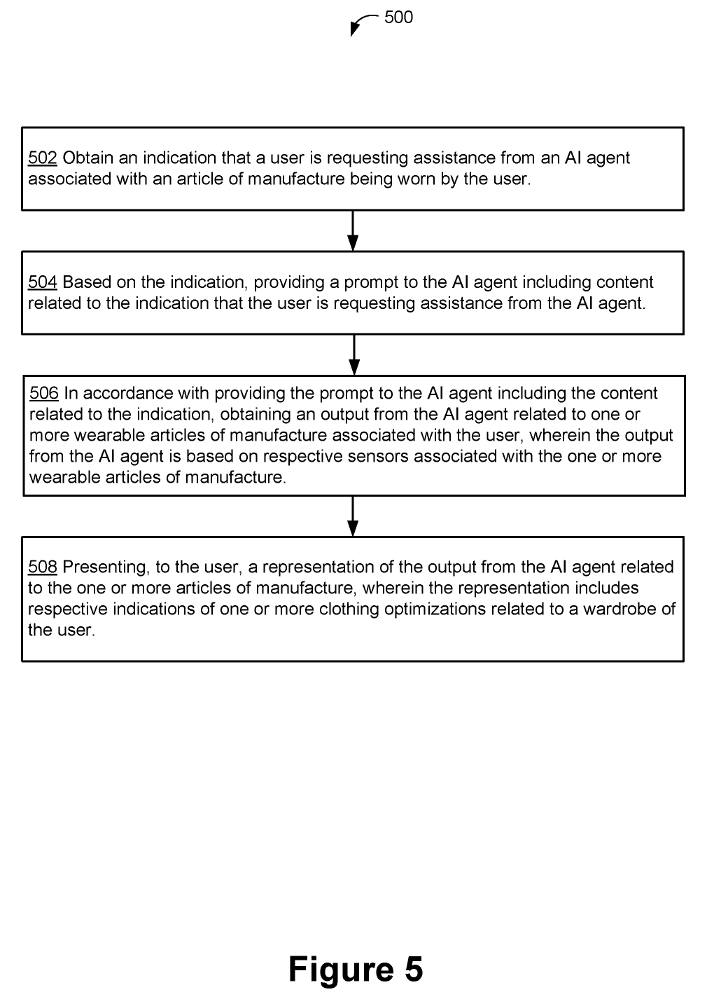

FIG. 5 shows an example method flow chart for intelligently recommending sensor-laden articles of manufacture to a user based on interactions by a user with an AI agent, in accordance with some embodiments.

(B1) In accordance with some embodiments, an example method 500 is provided. The method includes obtaining (502) an indication that a user is requesting assistance from an AI agent associated with an article of manufacture being worn by the user. For example, as shown in FIG. 2A, the user 702 wearing AR glasses 728 provides a verbal request to the AI agent asking for clothing recommendations.

The method 500 includes based on the indication, providing (504) a prompt to the AI agent including content related to the indication that the user is requesting assistance from the AI agent. For example, as shown in FIG. 2A, the user 702’s verbal request is provided as a prompt to the AI agent associated with the AR glasses 728.

The method 500 includes, in accordance with providing the prompt to the AI agent including the content related to the indication, obtaining (506) an output from the AI agent related to one or more wearable articles of manufacture associated with the user, wherein the output from the AI agent is based on respective sensors associated with the one or more wearable articles of manufacture. For example, as shown in FIG. 2B, the AI agent provides an output including the speech bubble 214 response and the recommendation display 210 showing suggested wearable articles.

The method 500 includes presenting (508), to the user, a representation of the output from the AI agent related to the one or more articles of manufacture, wherein the representation includes respective indications of one or more clothing optimizations related to a wardrobe of the user. For example, as shown in FIG. 2B, the recommendation display 210 presents the AI agent's output including smart pants 212-a, smart jacket 212-b, boots 212-c, hat 212-d, and ski goggles 212-e based on the user's predicted skiing activity.

(B2) In some embodiments of B1, the method 500 includes forming, via a processing device, a communication channel between the article of manufacture being worn by the user and an electronic device that is executing instructions for an AI agent associated with the user. For example, as shown in FIG. 2C, the user interface display 220 shows the smartjacket status indicator 222-1 and pants status indicator 222-2 indicating communication channels being established with the smart jacket 224-1 and smart pants 224-2.

(B3) In some embodiments of B2, the method 500 includes, based on the formed communication channel, identifying (i) a first group of sensors available at the article of manufacture for performing sensing relevant to a current activity being performed by the user, and (ii) a second group of sensors available at a set of articles of manufacture associated with the user. In some embodiments, the method 500 includes determining, based on applying the first and second groups of sensors to an AI model, that the second group of sensors is more suitable for the current activity being performed by the user. In some embodiments, applying the first and second groups of sensors to the AI model includes providing the first and second groups of sensors via a context window of a prompt provided to the AI model. And the method 500 includes, based on the determination that the second group of sensors is more suitable for the current activity being performed, disabling at least one sensor of the first group of sensors. For example, as shown in FIG. 2D, the system identifies sensors available on the user 702's clothing and determines which sensors are most suitable for the skiing activity being performed.

(B4) In some embodiments of B3, the method 500 includes, in accordance with another determination that the user is now performing another activity, distinct from the current activity: (i) activating the at least one sensor from the first group of sensors that was previously disabled, and (ii) disabling at least one sensor from the second group of sensors. For example, as shown in FIGS. 2C-2D, when the user 702 transitions from preparing to actively skiing, the system may activate additional motion sensors while disabling less relevant sensors to optimize performance.

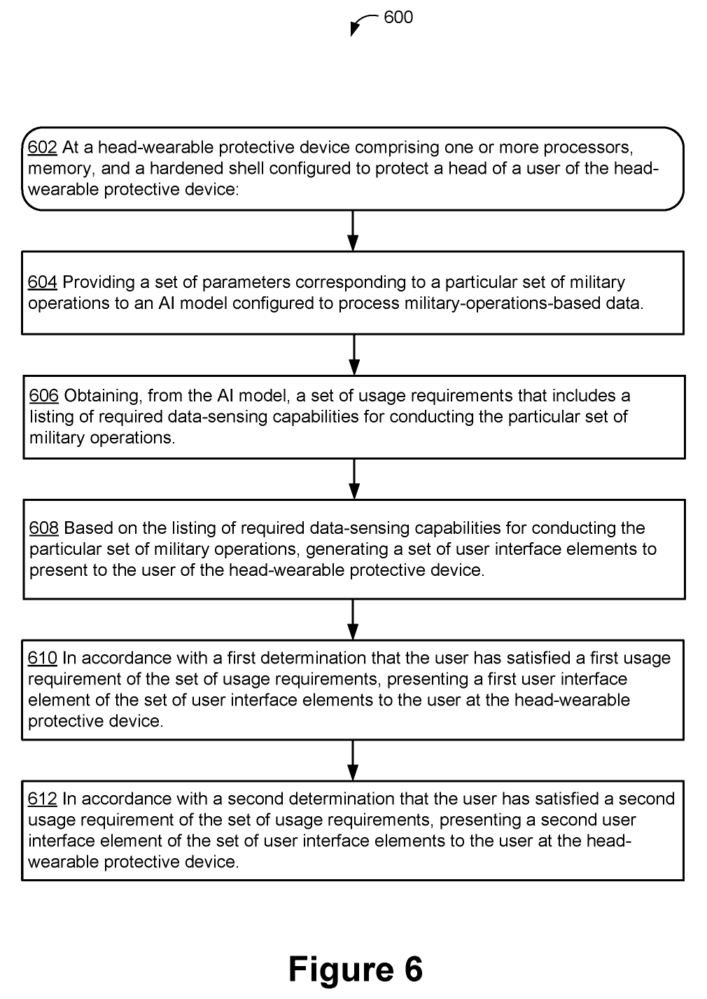

FIG. 6 shows an example method flow chart for using an AI system to determine and facilitate compliance with a set of equipment requirements, in accordance with some embodiments.

(C1) In some embodiments, an example method 600 is provided. The method 600 is configured to be performed at a head-wearable protective device comprising one or more processors, memory, and a hardened shell configured to protect a head of a user of the head-wearable protective device (602). For example, as shown in FIGS. 3D-3G, the head-wearable protective device 310 includes a display component for presenting user interface elements to the user 309.

The method 600 includes providing (604) a set of parameters corresponding to a particular set of military operations to an AI model configured to process military-operations-based data. For example, as shown in FIG. 3A, the user interface 302 allows an officer to set parameters including the title element 304-1 and checklist items 304-2 for the military operations.

The method 600 includes obtaining (606), from the AI model, a set of usage requirements that includes a listing of required data-sensing capabilities for conducting the particular set of military operations. In some embodiments, the AI model processes the set of parameters corresponding to the particular set of military operations and generates the set of usage requirements based on operational factors including terrain type, expected duration, environmental conditions, and mission objectives. For example, a reconnaissance mission in mountainous terrain may require motion sensing with high sensitivity for detecting falls, heart-rate sensing for monitoring exertion levels, and GPS sensing for location tracking, whereas a patrol mission in urban terrain may require audio sensing for detecting ambient sounds and imaging sensors for documenting observations. In some embodiments, the AI model accesses a database of historical military operations data to identify correlations between operation parameters and required sensing capabilities, and generates the set of usage requirements based on the identified correlations. For example, as shown in FIG. 3A, the user interface 302 displays checklist items 304-2 including heart-rate sensing, motion sensing, and other data-sensing capabilities required for the military operations.

The method 600 includes, based on the listing of required data-sensing capabilities for conducting the particular set of military operations, generating (608) a set of user interface elements to present to the user of the head-wearable protective device. In some embodiments, the set of user interface elements includes a prioritized checklist that orders equipment items based on criticality to the mission. In some embodiments, the set of user interface elements includes real-time status indicators that display whether each required sensing capability is currently being satisfied by the equipment worn by the user. In some embodiments, the set of user interface elements includes alternative equipment suggestions when a primary equipment item is unavailable or malfunctioning. For example, as shown in FIG. 3D, the checklist interface 324 presents user interface elements including the gear checklist 322 listing required equipment items, with status indicators showing connection status for each item.

The method 600 includes, in accordance with a first determination that the user has satisfied a first usage requirement of the set of usage requirements, presenting (610) a first user interface element of the set of user interface elements to the user at the head-wearable protective device. For example, as shown in FIG. 3D, the gear checklist 322 displayed via the checklist interface 324 indicates when the user 309 has satisfied equipment requirements such as connecting the helmet.

The method 600 includes, in accordance with a second determination that the user has satisfied a second usage requirement of the set of usage requirements, presenting (612) a second user interface element of the set of user interface elements to the user at the head-wearable protective device. For example, as shown in FIGS. 3E-3F, the gear checklist interface 330 and gear checklist interface 340 progressively update to show satisfaction of additional usage requirements as the user 309 dons and connects equipment items.

(C2) In some embodiments of C1, the method 600 includes, in accordance with determining that two respective pieces of equipment satisfy the first usage requirement, determining which of the two respective pieces of equipment optimize satisfaction of one or more equipment-fitting criteria.

(C3) In some embodiments of C2, the one or more equipment fitting criteria comprising one or more of: (i) an overall weight of a set of gear that a user will be wearing to satisfy the equipment-fitting criteria, and (ii) optimization of power savings and/or processing criteria.

(C4) In some embodiments of any one of C1 to C3, the method 600 includes, while the user is performing a respective military operation of the set of military operations, determining that one or more pieces of equipment is failing to satisfy a respective usage requirement of the first and second usage requirements. In some embodiments, the method 600 includes, in accordance to the determination that the one or more pieces of equipment are failing to satisfy the respective usage requirement, presenting an indication to the user regarding the failing to satisfy the respective usage requirement of the first and second usage requirements.

(C5) In some embodiments of C4, the indication includes information for mitigating the failing to satisfy the respective usage requirement.

(C6) In some embodiments of any one of C1 to C5, one or more of the first and second usage requirements are based on external conditions of a respective external environment where the set of military operations will be performed.

(D1) In accordance with some embodiments, a system that includes one or more wrist wearable devices and a pair of augmented-reality glasses, and the system is configured to perform operations corresponding to any of A1-C6.

(E1) In accordance with some embodiments, a non-transitory computer readable storage medium including instructions that, when executed by a computing device in communication with a pair of augmented-reality glasses, cause the computer device to perform operations corresponding to any of A1-C6.

(F1) In accordance with some embodiments, a method of operating a pair of augmented-reality glasses, including operations that correspond to any of A1-C6.

### Example Extended-Reality Systems

FIGS. 7A, 7B, 7C-1, and 7C-2, illustrate example XR systems that include AR and MR systems, in accordance with some embodiments. FIG. 7A shows a first XR system 700a and first example user interactions using a wrist-wearable device 726, a head-wearable device (e.g., AR device 728), and/or a HIPD 742. FIG. 7B shows a second XR system 700b and second example user interactions using a wrist-wearable device 726, AR device 728, and/or an HIPD 742. FIGS. 7C-1 and 7C-2 show a third MR system 700c and third example user interactions using a wrist-wearable device 726, a head-wearable device (e.g., an MR device such as a VR device), and/or an HIPD 742. As the skilled artisan will appreciate upon reading the descriptions provided herein, the above-example AR and MR systems (described in detail below) can perform various functions and/or operations.

The wrist-wearable device 726, the head-wearable devices, and/or the HIPD 742 can communicatively couple via a network 725 (e.g., cellular, near field, Wi-Fi, personal area network, wireless LAN). Additionally, the wrist-wearable device 726, the head-wearable device, and/or the HIPD 742 can also communicatively couple with one or more servers 730, computers 740 (e.g., laptops, computers), mobile devices 750 (e.g., smartphones, tablets), and/or other electronic devices via the network 725 (e.g., cellular, near field, Wi-Fi, personal area network, wireless LAN). Similarly, a smart textile-based garment, when used, can also communicatively couple with the wrist-wearable device 726, the head-wearable device(s), the HIPD 742, the one or more servers 730, the computers 740, the mobile devices 750, and/or other electronic devices via the network 725 to provide inputs.

Turning to FIG. 7A, a user 702 is shown wearing the wrist-wearable device 726 and the AR device 728 and having the HIPD 742 on their desk. The wrist-wearable device 726, the AR device 728, and the HIPD 742 facilitate user interaction with an AR environment. In particular, as shown by the first AR system 700a, the wrist-wearable device 726, the AR device 728, and/or the HIPD 742 cause presentation of one or more avatars 704, digital representations of contacts 706, and virtual objects 708. As discussed below, the user 702 can interact with the one or more avatars 704, digital representations of the contacts 706, and virtual objects 708 via the wrist-wearable device 726, the AR device 728, and/or the HIPD 742. In addition, the user 702 is also able to directly view physical objects in the environment, such as a physical table 729, through transparent lens(es) and waveguide(s) of the AR device 728. Alternatively, an MR device could be used in place of the AR device 728 and a similar user experience can take place, but the user would not be directly viewing physical objects in the environment, such as table 729, and would instead be presented with a virtual reconstruction of the table 729 produced from one or more sensors of the MR device (e.g., an outward facing camera capable of recording the surrounding environment).

The user 702 can use any of the wrist-wearable device 726, the AR device 728 (e.g., through physical inputs at the AR device and/or built-in motion tracking of a user’s extremities), a smart-textile garment, externally mounted extremity tracking device, the HIPD 742 to provide user inputs, etc. For example, the user 702 can perform one or more hand gestures that are detected by the wrist-wearable device 726 (e.g., using one or more EMG sensors and/or IMUs built into the wrist-wearable device) and/or AR device 728 (e.g., using one or more image sensors or cameras) to provide a user input. Alternatively, or additionally, the user 702 can provide a user input via one or more touch surfaces of the wrist-wearable device 726, the AR device 728, and/or the HIPD 742, and/or voice commands captured by a microphone of the wrist-wearable device 726, the AR device 728, and/or the HIPD 742. The wrist-wearable device 726, the AR device 728, and/or the HIPD 742 include an artificially intelligent digital assistant to help the user in providing a user input (e.g., completing a sequence of operations, suggesting different operations or commands, providing reminders, confirming a command). For example, the digital assistant can be invoked through an input occurring at the AR device 728 (e.g., via an input at a temple arm of the AR device 728). In some embodiments, the user 702 can provide a user input via one or more facial gestures and/or facial expressions. For example, cameras of the wrist-wearable device 726, the AR device 728, and/or the HIPD 742 can track the user 702’s eyes for navigating a user interface.

The wrist-wearable device 726, the AR device 728, and/or the HIPD 742 can operate alone or in conjunction to allow the user 702 to interact with the AR environment. In some embodiments, the HIPD 742 is configured to operate as a central hub or control center for the wrist-wearable device 726, the AR device 728, and/or another communicatively coupled device. For example, the user 702 can provide an input to interact with the AR environment at any of the wrist-wearable device 726, the AR device 728, and/or the HIPD 742, and the HIPD 742 can identify one or more back-end and front-end tasks to cause the performance of the requested interaction and distribute instructions to cause the performance of the one or more back-end and front-end tasks at the wrist-wearable device 726, the AR device 728, and/or the HIPD 742. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 742 can perform the back-end tasks and provide the wrist-wearable device 726 and/or the AR device 728 operational data corresponding to the performed back-end tasks such that the wrist-wearable device 726 and/or the AR device 728 can perform the front-end tasks. In this way, the HIPD 742, which has more computational resources and greater thermal headroom than the wrist-wearable device 726 and/or the AR device 728, performs computationally intensive tasks and reduces the computer resource utilization and/or power usage of the wrist-wearable device 726 and/or the AR device 728.

In the example shown by the first AR system 700a, the HIPD 742 identifies one or more back-end tasks and front-end tasks associated with a user request to initiate an AR video call with one or more other users (represented by the avatar 704 and the digital representation of the contact 706) and distributes instructions to cause the performance of the one or more back-end tasks and front-end tasks. In particular, the HIPD 742 performs back-end tasks for processing and/or rendering image data (and other data) associated with the AR video call and provides operational data associated with the performed back-end tasks to the AR device 728 such that the AR device 728 performs front-end tasks for presenting the AR video call (e.g., presenting the avatar 704 and the digital representation of the contact 706).

In some embodiments, the HIPD 742 can operate as a focal or anchor point for causing the presentation of information. This allows the user 702 to be generally aware of where information is presented. For example, as shown in the first AR system 700a, the avatar 704 and the digital representation of the contact 706 are presented above the HIPD 742. In particular, the HIPD 742 and the AR device 728 operate in conjunction to determine a location for presenting the avatar 704 and the digital representation of the contact 706. In some embodiments, information can be presented within a predetermined distance from the HIPD 742 (e.g., within five meters). For example, as shown in the first AR system 700a, virtual object 708 is presented on the desk some distance from the HIPD 742. Similar to the above example, the HIPD 742 and the AR device 728 can operate in conjunction to determine a location for presenting the virtual object 708. Alternatively, in some embodiments, presentation of information is not bound by the HIPD 742. More specifically, the avatar 704, the digital representation of the contact 706, and the virtual object 708 do not have to be presented within a predetermined distance of the HIPD 742. While an AR device 728 is described working with an HIPD, an MR headset can be interacted with in the same way as the AR device 728.

User inputs provided at the wrist-wearable device 726, the AR device 728, and/or the HIPD 742 are coordinated such that the user can use any device to initiate, continue, and/or complete an operation. For example, the user 702 can provide a user input to the AR device 728 to cause the AR device 728 to present the virtual object 708 and, while the virtual object 708 is presented by the AR device 728, the user 702 can provide one or more hand gestures via the wrist-wearable device 726 to interact and/or manipulate the virtual object 708. While an AR device 728 is described working with a wrist-wearable device 726, an MR headset can be interacted with in the same way as the AR device 728.

### Integration of Artificial Intelligence with XR Systems

FIG. 7A illustrates an interaction in which an artificially intelligent virtual assistant can assist in requests made by a user 702. The AI virtual assistant can be used to complete open-ended requests made through natural language inputs by a user 702. For example, in FIG. 7A the user 702 makes an audible request 744 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 7A also illustrates an example neural network 752 used in Artificial Intelligence applications. Uses of Artificial Intelligence (AI) are varied and encompass many distinct aspects of the devices and systems described herein. AI capabilities cover a diverse range of applications and deepen interactions between the user 702 and user devices (e.g., the AR device 728, an MR device 732, the HIPD 742, the wrist-wearable device 726). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein, that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user’s request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 702 can interact with an AI model through natural language inputs captured by a voice sensor, text inputs, or any other input modality that accepts natural language and/or a corresponding voice sensor module. In another instance, input is provided by tracking the eye gaze of a user 702 via a gaze tracker module. Additionally, the AI model can also receive inputs beyond those supplied by a user 702. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors’ data can be retrieved entirely from a single device (e.g., AR device 728) or from multiple devices that are in communication with each other (e.g., a system that includes at least two of an AR device 728, an MR device 732, the HIPD 742, the wrist-wearable device 726, etc.). The AI model can also access additional information (e.g., one or more servers 730, the computers 740, the mobile devices 750, and/or other electronic devices) via a network 725.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 728, an MR device 732, the HIPD 742, the wrist-wearable device 726) via the one or more networks. The cloud-computing platforms provide scalable computing resources, distributed computing, managed AI services, interference acceleration, pre-trained models, APIs, and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 728, an MR device 732, the HIPD 742, the wrist-wearable device 726), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 742), haptic feedback can provide information to the user 702. An AI model can also use the inputs described above to determine the appropriate modality and device(s) to present content to the user (e.g., a user walking on a busy road can be presented with an audio output instead of a visual output to avoid distracting the user 702).

### Example Augmented Reality Interaction

FIG. 7B shows the user 702 wearing the wrist-wearable device 726 and the AR device 728 and holding the HIPD 742. In the second AR system 700b, the wrist-wearable device 726, the AR device 728, and/or the HIPD 742 are used to receive and/or provide one or more messages to a contact of the user 702. In particular, the wrist-wearable device 726, the AR device 728, and/or the HIPD 742 detect and coordinate one or more user inputs to initiate a messaging application and prepare a response to a received message via the messaging application.

In some embodiments, the user 702 initiates, via a user input, an application on the wrist-wearable device 726, the AR device 728, and/or the HIPD 742 that causes the application to initiate on at least one device. For example, in the second AR system 700b the user 702 performs a hand gesture associated with a command for initiating a messaging application (represented by messaging user interface 712); the wrist-wearable device 726 detects the hand gesture; and, based on a determination that the user 702 is wearing the AR device 728, causes the AR device 728 to present a messaging user interface 712 of the messaging application. The AR device 728 can present the messaging user interface 712 to the user 702 via its display (e.g., as shown by user 702’s field of view 710). In some embodiments, the application is initiated and can be run on the device (e.g., the wrist-wearable device 726, the AR device 728, and/or the HIPD 742) that detects the user input to initiate the application, and the device provides another device operational data to cause the presentation of the messaging application. For example, the wrist-wearable device 726 can detect the user input to initiate a messaging application, initiate and run the messaging application, and provide operational data to the AR device 728 and/or the HIPD 742 to cause presentation of the messaging application. Alternatively, the application can be initiated and run at a device other than the device that detected the user input. For example, the wrist-wearable device 726 can detect the hand gesture associated with initiating the messaging application and cause the HIPD 742 to run the messaging application and coordinate the presentation of the messaging application.

Further, the user 702 can provide a user input provided at the wrist-wearable device 726, the AR device 728, and/or the HIPD 742 to continue and/or complete an operation initiated at another device. For example, after initiating the messaging application via the wrist-wearable device 726 and while the AR device 728 presents the messaging user interface 712, the user 702 can provide an input at the HIPD 742 to prepare a response (e.g., shown by the swipe gesture performed on the HIPD 742). The user 702’s gestures performed on the HIPD 742 can be provided and/or displayed on another device. For example, the user 702’s swipe gestures performed on the HIPD 742 are displayed on a virtual keyboard of the messaging user interface 712 displayed by the AR device 728.

In some embodiments, the wrist-wearable device 726, the AR device 728, the HIPD 742, and/or other communicatively coupled devices can present one or more notifications to the user 702. The notification can be an indication of a new message, an incoming call, an application update, a status update, etc. The user 702 can select the notification via the wrist-wearable device 726, the AR device 728, or the HIPD 742 and cause presentation of an application or operation associated with the notification on at least one device. For example, the user 702 can receive a notification that a message was received at the wrist-wearable device 726, the AR device 728, the HIPD 742, and/or other communicatively coupled device and provide a user input at the wrist-wearable device 726, the AR device 728, and/or the HIPD 742 to review the notification, and the device detecting the user input can cause an application associated with the notification to be initiated and/or presented at the wrist-wearable device 726, the AR device 728, and/or the HIPD 742.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 728 can present to the user 702 game application data and the HIPD 742 can use a controller to provide inputs to the game. Similarly, the user 702 can use the wrist-wearable device 726 to initiate a camera of the AR device 728, and the user can use the wrist-wearable device 726, the AR device 728, and/or the HIPD 742 to manipulate the image capture (e.g., zoom in or out, apply filters) and capture image data.

While an AR device 728 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user’s hand or other suitable surface (e.g., a table, whiteboard). In yet another embodiment, information may also be provided by locally dimming portions of a lens to emphasize portions of the environment in which the user’s attention should be directed. Some AR devices can present AR augments either monocularly or binocularly (e.g., an AR augment can be presented at only a single display associated with a single lens as opposed presenting an AR augmented at both lenses to produce a binocular image). In some instances, an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in an analogous manner to an MR headset, which is described below in the proceeding sections.

### Example Mixed Reality Interaction

Turning to FIGS. 7C-1 and 7C-2, the user 702 is shown wearing the wrist-wearable device 726 and an MR device 732 (e.g., a device capable of providing either an entirely VR experience or an MR experience that displays object(s) from a physical environment at a display of the device) and holding the HIPD 742. In the third AR system 700c, the wrist-wearable device 726, the MR device 732, and/or the HIPD 742 are used to interact within an MR environment, such as a VR game or other MR/VR application. While the MR device 732 presents a representation of a VR game (e.g., first MR game environment 720) to the user 702, the wrist-wearable device 726, the MR device 732, and/or the HIPD 742 detect and coordinate one or more user inputs to allow the user 702 to interact with the VR game.

In some embodiments, the user 702 can provide a user input via the wrist-wearable device 726, the MR device 732, and/or the HIPD 742 that causes an action in a corresponding MR environment. For example, the user 702 in the third MR system 700c (shown in FIG. 7C-1) raises the HIPD 742 to prepare for a swing in the first MR game environment 720. The MR device 732, responsive to the user 702 raising the HIPD 742, causes the MR representation of the user 722 to perform a similar action (e.g., raise a virtual object, such as a virtual sword 724). In some embodiments, each device uses respective sensor data and/or image data to detect the user input and provide an accurate representation of the user 702’s motion. For example, image sensors (e.g., SLAM cameras or other cameras) of the HIPD 742 can be used to detect a position of the HIPD 742 relative to the user 702’s body such that the virtual object can be positioned appropriately within the first MR game environment 720; sensor data from the wrist-wearable device 726 can be used to detect a velocity at which the user 702 raises the HIPD 742 such that the MR representation of the user 722 and the virtual sword 724 are synchronized with the user 702’s movements; and image sensors of the MR device 732 can be used to represent the user 702’s body, boundary conditions, or real-world objects within the first MR game environment 720.

In FIG. 7C-2, the user 702 performs a downward swing while holding the HIPD 742. The user 702’s downward swing is detected by the wrist-wearable device 726, the MR device 732, and/or the HIPD 742 and a corresponding action is performed in the first MR game environment 720. In some embodiments, the data captured by each device is used to improve the user’s experience within the MR environment. For example, sensor data of the wrist-wearable device 726 can be used to determine a speed and/or force at which the downward swing is performed and image sensors of the HIPD 742 and/or the MR device 732 can be used to determine a location of the swing and how it should be represented in the first MR game environment 720, which, in turn, can be used as inputs for the MR environment (e.g., game mechanics, which can use detected speed, force, locations, and/or aspects of the user 702’s actions to classify a user’s inputs (e.g., user performs a light strike, hard strike, critical strike, glancing strike, miss) or calculate an output (e.g., amount of damage)).

FIG. 7C-2 further illustrates that a portion of the physical environment is reconstructed and displayed at a display of the MR device 732 while the MR game environment 720 is being displayed. In this instance, a reconstruction of the physical environment 746 is displayed in place of a portion of the MR game environment 720 when object(s) in the physical environment are potentially in the path of the user (e.g., a collision with the user and an object in the physical environment are likely). Thus, this example MR game environment 720 includes (i) an immersive VR portion 748 (e.g., an environment that does not have a corollary counterpart in a nearby physical environment) and (ii) a reconstruction of the physical environment 746 (e.g., a table 750 and a cup on the table 750). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 726, the MR device 732, and/or the HIPD 742 are described as detecting user inputs, in some embodiments, user inputs are detected at a single device (with the single device being responsible for distributing signals to the other devices for performing the user input). For example, the HIPD 742 can operate an application for generating the first MR game environment 720 and provide the MR device 732 with corresponding data for causing the presentation of the first MR game environment 720, as well as detect the user 702’s movements (while holding the HIPD 742) to cause the performance of corresponding actions within the first MR game environment 720. Additionally, or alternatively, in some embodiments, operational data (e.g., sensor data, image data, application data, device data, and/or other data) of one or more devices is provided to a single device (e.g., the HIPD 742) to process the operational data and cause respective devices to perform an action associated with processed operational data.

In some embodiments, the user 702 can wear a wrist-wearable device 726, wear an MR device 732, wear smart textile-based garments 738 (e.g., wearable haptic gloves), and/or hold an HIPD 742 device. In this embodiment, the wrist-wearable device 726, the MR device 732, and/or the smart textile-based garments 738 are used to interact within an MR environment (e.g., any AR or MR system described above in reference to FIGS. 7A–7B). While the MR device 732 presents a representation of an MR game (e.g., second MR game environment 720) to the user 702, the wrist-wearable device 726, the MR device 732, and/or the smart textile-based garments 738 detect and coordinate one or more user inputs to allow the user 702 to interact with the MR environment.

In some embodiments, the user 702 can provide a user input via the wrist-wearable device 726, an HIPD 742, the MR device 732, and/or the smart textile-based garments 738 that causes an action in a corresponding MR environment. In some embodiments, each device uses respective sensor data and/or image data to detect the user input and provide an accurate representation of the user 702’s motion. While four different input devices are shown (e.g., a wrist-wearable device 726, an MR device 732, an HIPD 742, and a smart textile-based garment 738) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 738) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user’s experience within the MR environment. Although not shown, the smart textile-based garments 738 can be used in conjunction with an MR device and/or an HIPD 742.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a distinct set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory, computer-readable storage medium comprising instructions that, when executed by one or more processors, cause operations including:
in accordance with determining that a first wearable article of manufacture associated with a user is in electronic communication with a processing device associated with the user, obtaining sensor data from one or more first sensors;
based on the sensor data from the one or more first sensors, determining a first set of capabilities that is provided by the one or more first sensors;
based on applying, to an AI model, (i) behavioral data about the user, and (ii) the sensor data from the one or more first sensors, identifying an activity that the user is predicted to perform while wearing the first wearable article of manufacture;
in response to the identification of the activity that the user is predicted to perform, identifying a second wearable article of manufacture, the second wearable article of manufacture including a second set of sensors, the second set of sensors having capabilities for detecting aspects of the activity that the user is predicted to perform; and
in response to identifying the second wearable article of manufacture, presenting an indication suggesting to the user to don the second wearable article of manufacture.

2. The non-transitory, computer-readable storage medium of claim 1, wherein the one or more first sensors are distributed along a skin-facing surface of the first wearable article of manufacture.

3. The non-transitory, computer-readable storage medium of claim 1, wherein the first set of capabilities that is provided by the one or more first sensors relates to the first wearable article of manufacture.

4. The non-transitory, computer-readable storage medium of claim 1, wherein the behavioral data about the user is not based on an external environment of the user.

5. The non-transitory, computer-readable storage medium of claim 1, further comprising instructions for:
in accordance with identifying the second wearable article of manufacture, suggesting a modification to the activity that the user is predicted to perform.

6. The non-transitory, computer-readable storage medium of claim 1, further comprising instructions for:
determining, based on previous activity data, that the second wearable article of manufacture is more suitable for use with the one or more first sensors of the first wearable article of manufacture.

7. The non-transitory, computer-readable storage medium of claim 6, wherein the second wearable article of manufacture is determined to be more suitable with the one or more first sensors of the first wearable article of manufacture based on a determination that the second wearable article of manufacture increases sensing capabilities of the one or more first sensors.

8. A method, comprising:
in accordance with determining that a first wearable article of manufacture associated with a user is in electronic communication with a processing device associated with the user, obtaining sensor data from one or more first sensors;
based on the sensor data from the one or more first sensors, determining a first set of capabilities that is provided by the one or more first sensors;
based on applying, to an AI model, (i) behavioral data about the user, and (ii) the sensor data from the one or more first sensors, identifying an activity that the user is predicted to perform while wearing the first wearable article of manufacture;
in response to the identification of the activity that the user is predicted to perform, identifying a second wearable article of manufacture, the second wearable article of manufacture including a second set of sensors, the second set of sensors having capabilities for detecting aspects of the activity that the user is predicted to perform; and
in response to identifying the second wearable article of manufacture, presenting an indication suggesting to the user to don the second wearable article of manufacture.

9. The method of claim 8, wherein the one or more first sensors are distributed along a skin-facing surface of the first wearable article of manufacture.

10. The method of claim 8, wherein the first set of capabilities that is provided by the one or more first sensors relates to a sensor density of the first wearable article of manufacture.

11. The method of claim 8, wherein the behavioral data about the user is not based on an external environment of the user.

12. The method of claim 8, further comprising:
in accordance with identifying the second wearable article of manufacture, suggesting a modification to the activity that the user is predicted to perform.

13. The method of claim 8, further comprising:
determining, based on previous activity data, that the second wearable article of manufacture is more suitable for use with the one or more first sensors of the first wearable article of manufacture.

14. The method of claim 13, wherein the second wearable article of manufacture is determined to be more suitable with the one or more first sensors of the first wearable article of manufacture based on a determination that the second wearable article of manufacture increases sensing capabilities of the one or more first sensors.

15. An article of manufacture, comprising:
one or more processors; and
memory storing instructions that, when executed by the one or more processors, cause operations including:
in accordance with determining that the wearable article of manufacture associated with a user is in electronic communication with a processing device associated with the user, obtaining sensor data from one or more first sensors;
based on the sensor data from the one or more first sensors, determining a first set of capabilities that is provided by the one or more first sensors;
based on applying, to an AI model, (i) behavioral data about the user, and (ii) the sensor data from the one or more first sensors, identifying an activity that the user is predicted to perform while wearing the wearable article of manufacture;
in response to the identification of the activity that the user is predicted to perform, identifying a second wearable article of manufacture, the second wearable article of manufacture including a second set of sensors, the second set of sensors having capabilities for detecting aspects of the activity that the user is predicted to perform; and
in response to identifying the second wearable article of manufacture, presenting an indication suggesting to the user to don the second wearable article of manufacture.

16. The wearable article of manufacture of claim 15, wherein the one or more first sensors are distributed along a skin-facing surface of the wearable article of manufacture.

17. The wearable article of manufacture of claim 15, wherein the first set of capabilities that is provided by the one or more first sensors relates to a sensor density of the wearable article of manufacture.

18. The wearable article of manufacture of claim 15, wherein the behavioral data about the user is not based on an external environment of the user.

19. The wearable article of manufacture of claim 15, wherein the operations further include:
in accordance with identifying the second wearable article of manufacture, suggesting a modification to the activity that the user is predicted to perform.

20. The wearable article of manufacture of claim 15, wherein the operations further include:
determining, based on previous activity data, that the second wearable article of manufacture is more suitable for use with the one or more first sensors of the wearable article of manufacture.
